(19) United States
(12) Patent Application Publication
(10) Pub. No.: US 2026/0273866 A1
(43) Pub. Date: Sep. 17, 2026

(54) PHYSICS-GUIDED THERMAL HISTORY CONTROL AND MICROSTRUCTURE PREDICTION FOR LASER POWDER BED FUSION ADDITIVE MANUFACTURING

(71) Applicants: VIRGINIA TECH INTELLECTUAL PROPERTIES, INC., Blacksburg, VA (US); NUtech Ventures, Lincoln, NE (US)

(72) Inventors: Alexander Riensche, Radford, VA (US); Kaustubh Deshmukh, Blacksburg, VA (US); Kevin D. Cole, Lincoln, NE (US); Benjamin Bevans, Blacksburg, VA (US); Prahalada Rao, Radford, VA (US)

(21) Appl. No.: 19/569,966

(22) Filed: Mar. 17, 2026

Related U.S. Application Data
(60) Provisional application No. 63/773,199, filed on Mar. 17, 2025.

(51) Int. Cl. B29C 64/393; B29C 64/153; B33Y 10/00; B33Y 50/02; G06F 30/27; G06F 113/10; G06F 119/08; G06F 119/18

(52) U.S. Cl. CPC B29C 64/393; B29C 64/153; B33Y 10/00; B33Y 50/02; G06F 30/27; G06F 2113/10; G06F 2119/08; G06F 2119/18

(57) ABSTRACT

A thermal model for a laser powder bed fusion process discretizes a part geometry into nodes connected by edges to form a network graph, constructs a Laplacian matrix from the network graph, and computes eigenvalues and eigenvectors of the matrix. The thermal model predicts a thermal history of the part as a product of a part-shape-dependent term and a processing-condition-dependent term that are decoupled, enabling rapid iteration over candidate processing parameter levels without re-computing the eigenvalues and eigenvectors. A model predictive control approach determines a target thermal history based on a control strategy, iteratively simulates the thermal history at the candidate processing parameter levels over a prediction horizon, selects a processing parameter level that minimizes deviation from the target thermal history, and outputs a layer-by-layer process parameter plan. Characteristics of the solidified microstructure may be predicted by combining sensor-derived features and simulation-derived thermal history quantifiers in a machine learning model.

### CROSS-REFERENCE TO RELATED PATENT APPLICATION

This application claims the benefit of and priority to U.S. Provisional Application No. 63/773,199, filed Mar. 17, 2025, titled “MODEL PREDICTIVE CONTROL FOR IMPROVED PART QUALITY IN LASER POWDER BED FUSION,” the entire contents of which is hereby incorporated herein by reference.

### BACKGROUND

Laser powder bed fusion (LPBF) is an additive manufacturing process in which thin layers of metallic powder are deposited across a build plate and selectively melted by a rapidly scanning laser to fabricate complex three-dimensional parts in a layer-by-layer manner. LPBF is capable of producing high-value components from a range of metallic materials, including stainless steels, nickel-based superalloys, and titanium alloys, which are often difficult to manufacture using conventional subtractive or formative techniques. Despite these capabilities, the adoption of LPBF in safety-critical industries, such as aerospace and defense, is currently limited by the tendency of the process to produce inconsistent part properties. The spatiotemporal temperature distribution within a part during the LPBF process, commonly referred to as the thermal history, has a significant influence on characteristics such as porosity, solidified microstructure, surface finish, and geometric integrity. The thermal history is governed by a complex interplay of factors, including processing parameters, part geometry, part orientation, support structure placement, time between layers, and the presence of other parts on the build plate. Currently, the processing parameters for a given material are typically optimized through empirical build-and-test procedures using simple-shaped test coupons, such as cubes or cylinders. However, because the thermal history varies with part geometry, processing parameters optimized for simple shapes often do not transfer successfully to complex geometries, necessitating further rounds of experimentation. Moreover, processing parameters are typically maintained constant throughout the fabrication of a part, even though the thermal history may vary significantly between layers as the geometry changes. This approach can result in uneven temperature distributions that cause within-part variation in microstructure, mechanical properties, and geometric accuracy.

### SUMMARY

The following is a summary provided to introduce a selection of concepts in a simplified form that are further described below in the detailed description. This summary is not intended to identify key features or essential features of the claimed subject matter, nor is it intended to be used to limit the scope of the claimed subject matter.

A system is provided that includes at least one computing device and instructions stored in the at least one computing device. The instructions, when executed by at least one processor of the at least one computing device, cause the at least one computing device to receive a digital representation of a part geometry for a part to be fabricated by a laser powder bed fusion (LPBF) process and predict a thermal history of the part under nominal processing conditions using a thermal model. The thermal model discretizes the part geometry into a plurality of nodes connected by edges to form a network graph, constructs a discrete Laplacian matrix from the network graph, and computes eigenvalues and eigenvectors of the Laplacian matrix. The instructions further cause the at least one computing device to determine a target thermal history for the part based on a control strategy, and for each of a plurality of layers of the part, iteratively simulate the thermal history of the part at a plurality of candidate processing parameter levels over a prediction horizon of future layers using the thermal model and select a candidate processing parameter level that minimizes a deviation between the simulated thermal history and the target thermal history over the prediction horizon. The instructions further cause the at least one computing device to output a layer-by-layer process parameter plan specifying a processing parameter for each of the plurality of layers of the part based on the selected candidate processing parameter levels.

In various implementations, the thermal model may express the thermal history as a product of a part-shape-dependent term derived from the eigenvectors and eigenvalues of the Laplacian matrix and a processing-condition-dependent term. The part-shape-dependent term and the processing-condition-dependent term may be decoupled such that the eigenvalues and eigenvectors are pre-computed for each layer and the thermal history is iterative as a function of the candidate processing parameter levels without re-computing the eigenvalues and eigenvectors.

In various implementations, the control strategy may include one of: maintaining a constant end-of-cycle temperature across the plurality of layers, minimizing a spatial temperature gradient between layers, maintaining a constant cooling rate across the plurality of layers, maintaining a constant interlayer time across the plurality of layers, or matching the thermal history of a reference part fabricated with support structures. In various implementations, the control strategy may include matching the thermal history of the reference part fabricated with support structures, and the target thermal history may be a predicted thermal history of the reference part, such that the layer-by-layer process parameter plan adjusts the processing parameter to replicate the thermal history of the reference part without requiring physical support structures.

In various implementations, the prediction horizon may include future layers and the plurality of candidate processing parameter levels may include discrete laser power levels. The iterative simulation and selection may be repeated at intervals of a control horizon of simulated layers until all layers of the part have been processed. In various implementations, each simulated layer may correspond to a plurality of actual layers of the part in a superlayer approach, and the control horizon may correspond to a physical build height interval.

In various implementations, the instructions may further cause the at least one computing device to apply a smoothing operation to the layer-by-layer process parameter plan to reduce changes in the processing parameter between adjacent layers. The smoothing operation may include a moving average filter applied to the processing parameter across a window of build height.

In various implementations, the system may further include instructions that, when executed by the at least one processor, cause the at least one computing device to receive sensor data from an in-situ sensor array during fabrication of the part, extract sensor-derived features from the sensor data, obtain simulation-derived thermal history quantifiers from the thermal model, and input the sensor-derived features and the simulation-derived thermal history quantifiers to a machine learning model trained on ground-truth metallurgical characterization data to predict one or more characteristics of a solidified microstructure of the part. The sensor data may include at least one of thermal imaging data or meltpool intensity data. The sensor-derived features may include an end-of-cycle temperature, a spatial standard deviation of the end-of-cycle temperature, a mean of the meltpool intensity data, and a spatial standard deviation of the meltpool intensity data. The thermal imaging data may be acquired from a long-wave infrared thermal camera and the meltpool intensity data may be acquired from an optical tomography sensor. The machine learning model may include a nearest neighbors model. The one or more characteristics of the solidified microstructure may include at least one of a meltpool depth, a primary dendritic arm spacing, a grain aspect ratio, a grain major axis length, a standard deviation of grain orientation, a crystallographic texture ratio, or a microhardness.

A computer-implemented method is also provided. The method includes receiving, by at least one computing device, a digital representation of a part geometry for a part to be fabricated by a laser powder bed fusion process, and predicting, by the at least one computing device, a thermal history of the part under nominal processing conditions using a thermal model. The thermal model discretizes the part geometry into a plurality of nodes connected by edges to form a network graph, constructs a discrete Laplacian matrix from the network graph, and computes eigenvalues and eigenvectors of the Laplacian matrix. The method further includes determining, by the at least one computing device, a target thermal history for the part based on a control strategy, and for each of a plurality of layers of the part, iteratively simulating, by the at least one computing device, the thermal history of the part at a plurality of candidate processing parameter levels over a prediction horizon of future layers using the thermal model, and selecting a candidate processing parameter level that minimizes a deviation between the simulated thermal history and the target thermal history over the prediction horizon. The method further includes outputting, by the at least one computing device, a layer-by-layer process parameter plan specifying a processing parameter for each of the plurality of layers of the part based on the selected candidate processing parameter levels.

In various implementations, the method may further include calibrating the thermal model by adjusting heat transfer boundary coefficients based on a comparison of a predicted end-of-cycle temperature to a measured end-of-cycle temperature acquired from a long-wave infrared thermal camera. The heat transfer boundary coefficients may include a heat loss coefficient from the part to a build plate, a heat loss coefficient from the part to surrounding powder, and a heat loss coefficient from the part to a gas flow.

In various implementations, the method may further include acquiring in-situ sensor data during fabrication of the part, extracting sensor-derived features from the in-situ sensor data, obtaining simulation-derived thermal history quantifiers from the thermal model, and inputting the sensor-derived features and the simulation-derived thermal history quantifiers to a machine learning model trained on ground-truth metallurgical characterization data to predict one or more characteristics of a solidified microstructure of the part.

A non-transitory computer-readable medium is also provided. The non-transitory computer-readable medium stores instructions that, when executed by at least one processor, cause the at least one processor to receive a digital representation of a part geometry for a part to be fabricated by a laser powder bed fusion process, predict a thermal history of the part under nominal processing conditions using a thermal model, determine a target thermal history for the part based on a control strategy, for each of a plurality of layers of the part iteratively simulate the thermal history of the part at a plurality of candidate processing parameter levels over a prediction horizon of future layers using the thermal model and select a candidate processing parameter level that minimizes a deviation between the simulated thermal history and the target thermal history over the prediction horizon, and output a layer-by-layer process parameter plan specifying a processing parameter for each of the plurality of layers of the part based on the selected candidate processing parameter levels. The thermal model discretizes the part geometry into a plurality of nodes connected by edges to form a network graph, constructs a discrete Laplacian matrix from the network graph, and computes eigenvalues and eigenvectors of the Laplacian matrix.

In various implementations, the plurality of candidate processing parameter levels may include a plurality of discrete laser power levels constrained between a lower bound selected to avoid lack-of-fusion porosity and an upper bound selected to avoid keyhole porosity.

In various implementations, the instructions may further cause the at least one processor to receive sensor data from an in-situ sensor array during fabrication of the part, extract sensor-derived features from the sensor data, obtain simulation-derived thermal history quantifiers from the thermal model, and input the sensor-derived features and the simulation-derived thermal history quantifiers to a machine learning model to predict one or more characteristics of a solidified microstructure of the part.

In various implementations, the instructions may further cause the at least one processor to transmit the layer-by-layer process parameter plan to slicer software of an LPBF machine for generating machine-executable instructions for fabrication of the part.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a schematic block diagram of an additive manufacturing environment according to various implementations of the present disclosure.

FIG. 2 depicts thermal simulation predictions and scanning electron microscopy micrographs illustrating the effect of part geometry and processing conditions on solidified microstructure in laser powder bed fusion according to various implementations of the present disclosure.

FIG. 3 is a schematic representation of a graph theory thermal modeling approach for predicting thermal history of a laser powder bed fusion part according to various implementations of the present disclosure.

FIG. 4 is a schematic representation of a model predictive control approach for layer-by-layer process parameter optimization according to various implementations of the present disclosure.

FIGS. 5A and 5B are a flowchart of a method for physics-guided thermal history control and microstructure prediction in laser powder bed fusion according to various implementations of the present disclosure.

FIGS. 6A and 6B depict an implementation of a constant end-of-cycle temperature control strategy for a cone-shaped part according to various implementations of the present disclosure.

FIGS. 7A and 7B depict an implementation of an end-of-cycle temperature gradient minimization control strategy for a cone-shaped part according to various implementations of the present disclosure.

FIGS. 8A through 8D depict an implementation of a constant cooling rate control strategy for a cone-shaped part according to various implementations of the present disclosure.

FIGS. 9A and 9B depict an implementation of a constant interlayer time control strategy for a cone-shaped part according to various implementations of the present disclosure.

FIGS. 10A and 10B depict an implementation of a support-matching control strategy for an arch-shaped part according to various implementations of the present disclosure.

FIG. 11 is a schematic representation of a microstructure prediction framework according to various implementations of the present disclosure.

FIG. 12 depicts a comparison of prediction accuracy across model categories and microstructure characteristics according to various implementations of the present disclosure.

FIGS. 13A and 13B depict a comparison of primary dendritic arm spacing and microhardness for a trumpet-shaped part according to various implementations of the present disclosure.

### DETAILED DESCRIPTION

This patent application generally relates to additive manufacturing, and more particularly to physics-guided thermal history control and microstructure prediction in the laser powder bed fusion (LPBF) process.

In LPBF, thin layers of metallic powder are deposited across a build plate and selectively melted by a laser to fabricate parts in a layer-by-layer manner. The spatiotemporal temperature distribution within a part during the build process, referred to as the thermal history, has a significant influence on the solidified microstructure and resulting part properties, including grain size, crystallographic texture, surface finish, geometric integrity, and mechanical strength. The thermal history is governed by a complex interplay of factors, including processing parameters, part geometry, part orientation, support structure placement, time between layers, and other build conditions. Because the thermal history varies with part geometry, processing parameters that have been empirically optimized for simple test shapes often do not transfer successfully to complex geometries. Moreover, when processing parameters are maintained constant throughout the fabrication of a part, the thermal history may vary significantly between layers as the cross-section, overhangs, and other geometric features change. This uneven temperature distribution can result in heterogeneous microstructure, inconsistent functional properties, thermal-induced geometric distortion, degraded surface finish of internal features, and in some cases, build failures such as recoater crashes.

In one or more implementations, a computing device generates a layer-by-layer process parameter plan for an LPBF part using a model predictive control approach guided by a physics-based thermal simulation. The physics-based thermal simulation may be a graph theory-based computational model that predicts the thermal history of a part as a function of its geometry and processing conditions. The model predictive control approach iteratively adjusts the processing parameters, such as laser power, on a layer-by-layer basis before the part is printed, such that the predicted thermal history of the part matches a predetermined target thermal history. The target thermal history may be determined according to one of a plurality of control strategies, such as maintaining a constant layer temperature, minimizing thermal gradients between layers, maintaining a constant cooling rate, maintaining a constant time between layers, or matching the thermal history of a reference part fabricated with support structures. The resulting process parameter plan is communicated to the LPBF machine for use during fabrication. Because the graph theory-based thermal simulation decouples the effect of part shape from the effect of processing conditions, the thermal history can be rapidly iterated as a function of candidate processing parameters without re-computing the spatial decomposition of the part geometry, thereby enabling the iterative optimization inherent to model predictive control.

In one or more implementations, the computing device further predicts characteristics of the solidified microstructure of the part by combining thermal history quantifiers derived from the physics-based thermal simulation with process signatures acquired from in-situ sensors. The in-situ sensors may include a long-wave infrared thermal camera that measures layer-wise surface temperatures and an optical tomography sensor that measures meltpool intensity. The simulation-derived thermal history quantifiers and the sensor-derived process signatures are provided as inputs to a machine learning model trained on ground-truth metallurgical characterization data. By combining physics-based simulation data with real-time sensor data, the machine learning model captures both the sub-surface thermal gradients predicted by the simulation and the process stochasticity reflected in the sensor measurements, thereby enabling prediction of multi-scale microstructure characteristics with improved accuracy relative to approaches that rely on either simulation data or sensor data alone.

In one or more implementations, the physics-guided thermal history control approach may provide one or more of the following advantages: reduced within-part variation in grain size, improved geometric accuracy, improved surface integrity of downward-facing and internal features, consistent mechanical properties such as microhardness, elimination of build failures caused by recoater contact with overheated regions of the part, and elimination of support structures in parts with overhang features while maintaining comparable thermal history and microstructure to corresponding supported parts. The elimination of support structures can reduce post-processing machining time, material usage, and manufacturing cost. Additionally, the physics-guided approach may accelerate process qualification for new part geometries by generating a shape-specific process parameter plan through computational simulation rather than empirical build-and-test experimentation. In one or more implementations, the graybox microstructure prediction approach may enable rapid, non-destructive, and in-situ assessment of part quality during or after fabrication, reducing reliance on costly and time-intensive post-process metallurgical characterization techniques.

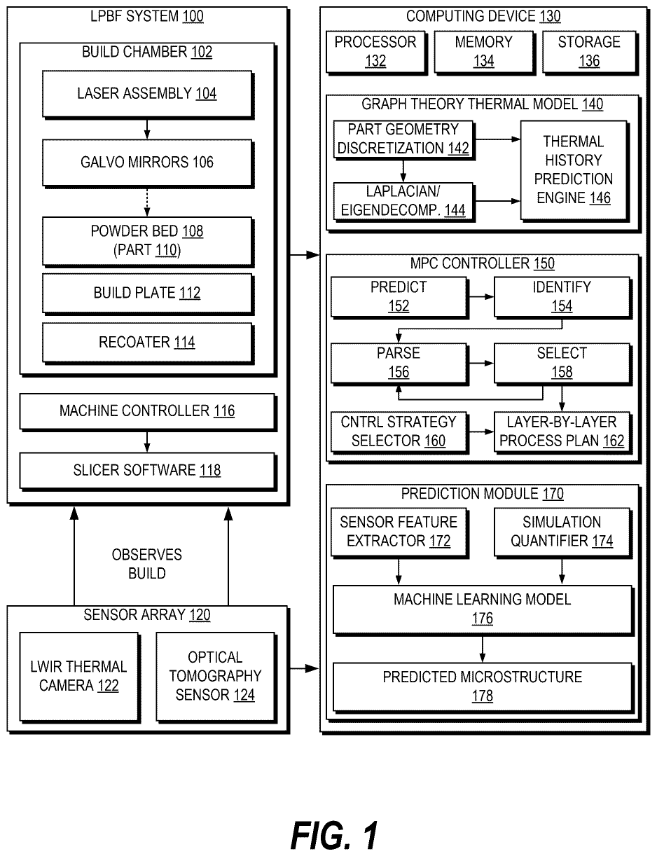

Turning to FIG. 1, shown is a schematic block diagram of an additive manufacturing environment according to various implementations of the present disclosure. The additive manufacturing environment facilitates physics-guided control of thermal history and prediction of solidified microstructure in a laser powder bed fusion (LPBF) process. The additive manufacturing environment includes an LPBF system 100, a sensor array 120, and a computing device 130.

The LPBF system 100 includes a build chamber 102 that encloses the components involved in the layer-by-layer fabrication of a part 110. The build chamber 102 may maintain an inert atmosphere, such as argon or nitrogen gas, during fabrication to mitigate oxidation and other deleterious reactions.

The LPBF system 100 includes a laser assembly 104 that generates a laser beam for selectively melting metallic powder. In various implementations, the laser assembly 104 may include an infrared laser, such as a ytterbium (Yb) fiber laser having a wavelength of approximately 1070 nanometers (nm), with a power output in the range of approximately 100 watts (W) to approximately 500 W. For example, in one implementation, the laser assembly 104 has a maximum power output of 400 W. The laser beam from the laser assembly 104 is directed by galvanometric mirrors 106 onto a powder bed 108. The galvanometric mirrors 106 steer the laser beam across the surface of the powder bed 108 in accordance with a scan path derived from a digital representation of the part 110.

The powder bed 108 includes a layer of metallic powder material deposited on a build plate 112. In various implementations, the metallic powder material may include stainless steel alloys (e.g., 316L), nickel-based superalloys (e.g., Inconel 718), titanium alloys, or other metallic materials suitable for LPBF processing. The metallic powder material may have a particle size distribution in the range of approximately 15 micrometers (μm) to approximately 45 μm (D10 to D90). As the laser beam selectively melts the powder material, the part 110 is formed within the powder bed 108 in a layer-by-layer manner. Each layer may have a thickness in the range of approximately 20 μm to approximately 80 μm. For example, in various implementations, the layer thickness may be approximately 20 μm, approximately 30 μm, or approximately 40 μm.

A recoater 114 deposits successive layers of powder material across the build plate 112 between laser scanning operations. The recoater 114 may include a metal or polymer blade that traverses the powder bed 108 to spread a uniform layer of powder. A recoat cycle time may be approximately 10 seconds.

The LPBF system 100 further includes a machine controller 116 and slicer software 118. The slicer software 118 receives a layer-by-layer process plan and converts it into machine-executable instructions, including scan paths, laser power settings, scan velocities, hatch spacing, and other processing parameters for each layer of the part 110. The machine controller 116 receives the machine-executable instructions from the slicer software 118 and controls the operation of the laser assembly 104, the galvanometric mirrors 106, and the recoater 114 during fabrication of the part 110.

In various implementations, the processing parameters may include a laser power (P) in the range of approximately 100 W to approximately 500 W. For example, laser power settings of approximately 146 W, approximately 195 W, approximately 230 W, and approximately 240 W have been used in various implementations. The processing parameters may further include a scan velocity (V) in the range of approximately 500 millimeters per second (mm/s) to approximately 1200 mm/s. For example, scan velocities of approximately 800 mm/s, approximately 928 mm/s, and approximately 1083 mm/s have been used in various implementations. The processing parameters may further include a hatch spacing (H) in the range of approximately 0.05 millimeters (mm) to approximately 0.12 mm, such as approximately 0.09 mm. The processing parameters may further include a layer thickness (L) in the range of approximately 0.02 mm to approximately 0.08 mm, such as approximately 0.02 mm, approximately 0.03 mm, or approximately 0.04 mm. A volumetric energy density (Eᵥ) may be calculated as a function of laser power, scan velocity, hatch spacing, and layer thickness (Eᵥ=P/(V×H×L)), and may range from approximately 69 Joules per cubic millimeter (J/mm³) to approximately 172 J/mm³. For example, volumetric energy densities of approximately 69 J/mm³, approximately 100 J/mm³, and approximately 111 J/mm³ have been used in various implementations. The build plate 112 may be preheated to a temperature of approximately 70° C. In various implementations, the laser may be scanned in a stripe pattern having a stripe width of approximately 7 mm, a stripe overlap of approximately 0.03 mm, and an inter-layer rotation angle of approximately 67°. The laser spot size may be approximately 70 μm.

The sensor array 120 is positioned to observe the build process within the build chamber 102 during fabrication of the part 110. The sensor array 120 includes a long-wave infrared (LWIR) thermal camera 122 and an optical tomography sensor 124.

The LWIR thermal camera 122 acquires thermal images of the top surface of the powder bed 108, from which an end-of-cycle temperature (Tₑ) and a spatial standard deviation of the end-of-cycle temperature (σTₑ) may be extracted for each layer. The end-of-cycle temperature (Tₑ) represents the average surface temperature of a layer after the layer has been melted by the laser, a subsequent layer of powder has been deposited by the recoater 114, but the subsequent layer has not yet been melted. In various implementations, the LWIR thermal camera 122 may operate in a spectral range of approximately 7.5 μm to approximately 14 μm and acquire thermal images at a frame rate of approximately 30 hertz (Hz) to approximately 33 Hz. For example, in one implementation, the LWIR thermal camera 122 has a spectral range of 7.5 μm to 13 μm and a frame rate of 30 Hz with a resolution of 640×840 pixels. In another implementation, the LWIR thermal camera 122 has a spectral range of 8 μm to 14 μm and a frame rate of 33 Hz with a resolution of 640×480 pixels. The LWIR thermal camera 122 may be calibrated to an absolute temperature scale using reference thermocouple measurements.

The optical tomography sensor 124 captures meltpool intensity data during laser scanning. The optical tomography sensor 124 may include a near-infrared (NIR) camera operating in a spectral range of approximately 750 nm to approximately 800 nm. In various implementations, the optical tomography sensor 124 may acquire images at a frame rate of approximately 4 Hz with a resolution of approximately 3036×4024 pixels. From the meltpool intensity data, a mean meltpool intensity (Iₘ) and a spatial standard deviation of the meltpool intensity (σIₘ) may be extracted for each layer. The meltpool intensity (Iₘ) is proportional to the meltpool temperature and captures instantaneous, localized variations in the meltpool and hatch-level temperatures resulting from changes in processing parameters. The sensor data acquired by the LWIR thermal camera 122 and the optical tomography sensor 124 is communicated to the computing device 130.

The computing device 130 includes at least one processor 132, memory 134, and storage 136. The processor 132 may include one or more central processing units (CPUs), graphics processing units (GPUs), or other processing circuits. The memory 134 may include volatile memory, such as random access memory (RAM), for storing data during computation. The storage 136 may include non-volatile storage media, such as solid-state drives, hard disk drives, or other non-transitory computer-readable media, for storing instructions and data. The computing device 130 may include, for example, a desktop computer, a server, a workstation, or the like. The computing device 130 stores and executes instructions that implement a graph theory thermal model 140, a model predictive control (MPC) controller 150, and a microstructure prediction module 170.

The graph theory thermal model 140 predicts the spatiotemporal temperature distribution, referred to herein as the thermal history, of the part 110 during the LPBF process. The graph theory thermal model 140 includes a part geometry discretization component 142, a Laplacian and eigendecomposition component 144, and a thermal history prediction engine 146.

The part geometry discretization component 142 receives a digital representation of the part 110, such as a computer-aided design (CAD) model, and discretizes the geometry into a plurality of nodes connected by edges to form a network graph. Each node represents a sampled spatial point (x, y, z) within the part 110, and each edge represents a heat transfer pathway between adjacent nodes. The resulting network graph captures the effect of part geometry on heat diffusion between nodes. In various implementations, the node density may be in the range of approximately 1 node per cubic millimeter (nodes/mm³) to approximately 2.25 nodes/mm³.

The Laplacian and eigendecomposition component 144 constructs a discrete Laplacian matrix (L) from the network graph. The Laplacian matrix replaces the continuous Laplacian operator of the heat diffusion equation with a discrete spatial equivalent that encodes the geometric relationships between nodes. The Laplacian and eigendecomposition component 144 computes the eigenvalues (Λ) and eigenvectors (φ) of the Laplacian matrix, which represent the spatial modes of heat transfer within the part 110 for a given layer. In various implementations, the eigenvalues and eigenvectors may be pre-computed for each layer of the part 110 and stored in the memory 134, such that the effect of different processing parameters on the thermal history can be evaluated without re-computing the spatial decomposition. Heat losses at the boundaries of the part 110 are incorporated by augmenting the Laplacian matrix with type 3 (convection) boundary conditions.

The thermal history prediction engine 146 predicts the thermal history of the part 110 as a function of the eigenvalues, eigenvectors, and processing conditions. In the graph theory thermal model 140, the thermal history T(x, y, z, t) at each spatial point and time is expressed as a product of a part-shape-dependent term and a processing-condition-dependent term. The part-shape-dependent term is derived from the eigenvectors (φ), eigenvalues (Λ), and a cooling time (t), and includes a unitless gain factor (g) that scales the cooling behavior of the model. In various implementations, the gain factor (g) may be approximately 0.6. The processing-condition-dependent term is a function of the laser absorptivity (Aₑ), the scan path length per layer (S_{I}), the laser power (P), the scan velocity (V), the volume of material melted per layer (ν), and the temperature of the preceding layer. In various implementations, the laser absorptivity (Aₑ) may be approximately 0.6. The material properties used in the graph theory thermal model 140 may include a thermal conductivity (k) of approximately 17 W·m⁻¹·° C., a density (ρ) of approximately 8,193 kg·m⁻³, and a specific heat (cup) of approximately 540 J·kg⁻¹·° C.⁻¹. In various implementations, the material properties may be evaluated at a fixed temperature, such as approximately 250° C. Because the part-shape-dependent term and the processing-condition-dependent term are decoupled, the thermal history prediction engine 146 can rapidly iterate over different processing parameter levels without re-computing the spatial decomposition. The solution is semi-analytical in nature, being discrete in space and continuous in time, which eliminates the need for stepping through time and further reduces the computational burden relative to finite element approaches. This decoupling enables the iterative optimization performed by the MPC controller 150.

The thermal history prediction engine 146 outputs thermal history quantifiers including a predicted end-of-cycle temperature and a predicted cooling time for each layer of the part 110. The predicted end-of-cycle temperature represents the model-predicted average steady-state layer temperature after a layer has been melted, a subsequent layer of powder has been deposited, but the subsequent layer has not yet been melted. The predicted cooling time represents the duration for the temperature at a region of interest to decay from a peak temperature at the instant of laser exposure to a threshold temperature. In various implementations, the threshold temperature may be approximately one-half the liquidus temperature of the metallic powder material. For example, for stainless steel 316L having a liquidus temperature of approximately 1320° C., the threshold temperature may be approximately 700° C. Similarly, for Inconel 718 having a melting temperature of approximately 1335° C., the threshold temperature may be approximately 700° C. The thermal history quantifiers are provided to both the MPC controller 150 and the microstructure prediction module 170.

In various implementations, the graph theory thermal model 140 is calibrated using sensor data acquired from the LWIR thermal camera 122. Calibration involves adjusting heat transfer boundary coefficients, including a heat loss coefficient from the part 110 to the build plate 112 (Hₛ), a heat loss coefficient from the part 110 to the surrounding powder (Hₚ), and a heat loss coefficient from the part 110 to the gas flow (Hₑ). For example, in one implementation using stainless steel 316L, the calibrated values are Hₛ≈20,000 W·m⁻²·° C., Hₚ≈8 W·m⁻²·° C., and Hₑ≈10 W·m⁻²·° C. In another implementation using stainless steel 316L with a different machine configuration, the calibrated values are Hₛ≈20,000 W·m⁻²·° C., Hₚ≈30 W·m⁻²·° C., and Hₑ≈30 W·m⁻²·° C. Calibration can be performed by comparing the predicted end-of-cycle temperature to the measured end-of-cycle temperature (Tₑ) from the LWIR thermal camera 122 such that the symmetric mean absolute percentage error (SMAPE) is within a target accuracy, such as within approximately 5% to approximately 8%. In various implementations, the calibration may be performed a priori using data from a separate reference build conducted on the same machine and material. Once calibrated, the heat transfer boundary coefficients are maintained constant for subsequent predictions across different part geometries and processing conditions. In various implementations, the calibrated graph theory thermal model 140 has been validated across a plurality of part geometries, including cone, overhang, spring, bell crank, arch, and trumpet geometries, with a SMAPE within approximately 2% to approximately 8% and an RMSE within approximately 4° C. to approximately 15° C. across all geometries. The simulation time for a single iteration ranges from approximately 1 minute for simpler geometries to approximately 15 minutes for more complex geometries.

The MPC controller 150 implements a model predictive control approach to autonomously generate a layer-by-layer process parameter plan for the part 110 before fabrication begins. The MPC controller 150 operates using the thermal history predictions from the graph theory thermal model 140 and does not require real-time sensor data from the sensor array 120 during the process planning phase. The sensor array 120 may be used for calibration and validation of the graph theory thermal model 140 as described above, and for providing data to the microstructure prediction module 170 as described below, but the MPC controller 150 generates the process parameter plan based on a priori thermal simulations. The MPC controller 150 includes a predict component 152, an identify component 154, a parse component 156, and a select component 158 that operate in an iterative sequence.

The predict component 152 uses the graph theory thermal model 140 to predict the thermal history of the part 110 under nominal, or default, processing conditions. The nominal processing conditions may include manufacturer-recommended settings for the laser power, scan velocity, hatch spacing, and layer thickness. For example, in one implementation using stainless steel 316L, the nominal conditions include a laser power of 230 W, a scan velocity of 928 mm/s, a hatch spacing of 0.09 mm, and a layer thickness of 0.04 mm, resulting in a volumetric energy density of approximately 69 J/mm³. In another implementation using stainless steel 316L, the nominal conditions include a laser power of 195 W, a scan velocity of 1083 mm/s, a hatch spacing of 0.09 mm, and a layer thickness of 0.02 mm, resulting in a volumetric energy density of approximately 100 J/mm³. In yet another implementation using Inconel 718, the nominal conditions include a laser power of 240 W and a scan velocity of 800 mm/s, resulting in a volumetric energy density of approximately 111 J/mm³. The predicted thermal history under nominal conditions is referred to herein as the original thermal history. The thermal simulation for the predict component 152 may converge within approximately 1 minute to approximately 15 minutes per part, depending on the geometric complexity.

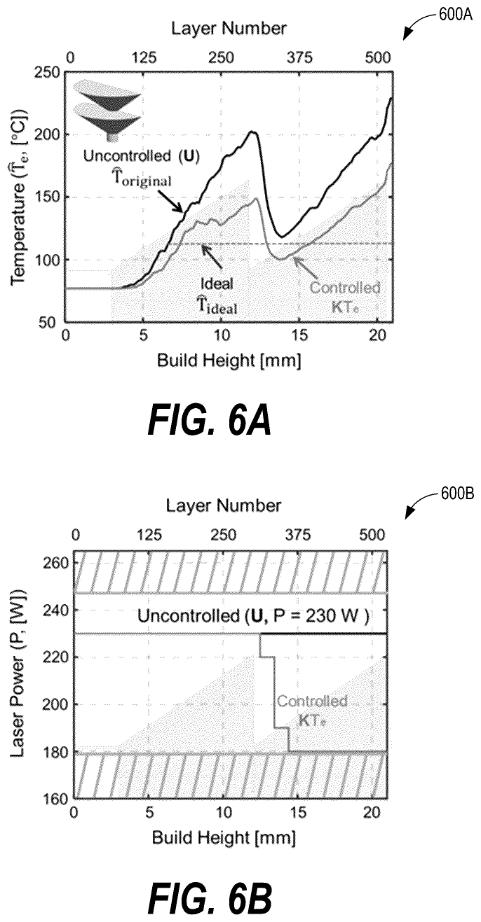

The identify component 154 determines a target thermal history based on a control strategy selected by a control strategy selector 160. The control strategy selector 160 selects a thermal history control strategy from among a plurality of available strategies. Available control strategies may include, for example, maintaining a constant end-of-cycle temperature, minimizing a spatial temperature gradient between layers, maintaining a constant cooling rate, maintaining a constant interlayer time, matching the thermal history of a reference part (e.g., a part fabricated with support structures), or combinations thereof. The selected control strategy determines the form of the target thermal history that the MPC controller 150 strives to achieve. For example, under the constant end-of-cycle temperature strategy, the target thermal history is set as an upper bound on the end-of-cycle temperature, such as the average of the original thermal history over the entire part (e.g., approximately 110° C. for a cone-shaped part). Under the support-matching strategy, the target thermal history is the predicted thermal history of a corresponding part fabricated with support structures, such that the MPC controller 150 adjusts the processing parameters to replicate the thermal benefits of support structures without requiring their physical presence. Under the constant interlayer time strategy, the interlayer time is maintained at a fixed value, such as approximately 57 seconds, across all layers by means of a virtual part scanned at zero laser power to compensate for the reduction in scan area between layers. Additional details regarding the available control strategies are described with reference to FIG. 6.

The parse component 156 predicts the thermal history of the part 110 for a plurality of candidate processing parameter levels over a prediction horizon of k future layers. In various implementations, the prediction horizon k may be approximately 5 layers. The parse component 156 evaluates h discrete candidate levels of laser power, where i={1 . . . h}, for each of the k future layers using the graph theory thermal model 140. In various implementations, the number of candidate laser power levels h may be approximately 5. For example, in one implementation using stainless steel 316L with a layer thickness of 0.04 mm, the five discrete laser power levels are approximately 180 W, approximately 198 W, approximately 214 W, approximately 230 W, and approximately 240 W, with the laser power constrained between approximately 182 W and approximately 245 W to avoid lack-of-fusion porosity at the lower bound and keyhole porosity at the upper bound. In another implementation using stainless steel 316L with a layer thickness of 0.02 mm, the five discrete laser power levels are approximately 146 W, approximately 156 W, approximately 176 W, approximately 195 W, and approximately 225 W, with the laser power constrained between approximately 146 W and approximately 225 W. Because the eigenvalues and eigenvectors of the Laplacian matrix are pre-computed, the parse component 156 can evaluate the thermal history as a function of the candidate laser power levels without re-computing the spatial decomposition. In various implementations, the time to compute a single iteration of the parse component 156 may range from approximately 1 minute to approximately 15 minutes depending on the geometric complexity of the part 110.

The select component 158 selects the candidate processing parameter that minimizes the deviation of the predicted thermal history from the target thermal history over the prediction horizon. In various implementations, the select component 158 selects the laser power level that minimizes the mean absolute deviation (MAD) between the predicted thermal history and the target thermal history over the k future layers.

The parse component 156 and the select component 158 operate iteratively at intervals of a control horizon until the entire part 110 has been processed. In various implementations, the control horizon is approximately every 2 simulated layers. In implementations where a simulated layer corresponds to multiple actual layers (a superlayer approach), the control horizon corresponds to a physical build height interval. For example, in one implementation where each simulated layer represents 3 actual layers of 40 μm each (superlayer thickness of 0.12 mm), the optimal laser power is determined every 240 μm of build height. In another implementation where each simulated layer represents 5 actual layers of 20 μm each (superlayer thickness of 0.1 mm), the optimal laser power is determined every 200 μm of build height. The MPC controller 150 may autonomously generate the complete process parameter plan within approximately 35 minutes to approximately 6 hours, depending on the geometric complexity of the part 110. For example, an arch-shaped part approximately 25 mm tall may require approximately 35 minutes, a cone-shaped part approximately 21 mm tall may require less than approximately 4 hours, and a bell crank part approximately 42 mm tall may require approximately 5 hours.

The output of the iterative process is a layer-by-layer process plan 162 that specifies the processing parameters, such as laser power, for each layer or group of layers of the part 110. In various implementations, a smoothing operation may be applied to the process plan 162 to reduce abrupt changes in laser power between adjacent layers, which can cause defects at the interface of layers where large process parameter changes occur. For example, a moving average filter, such as a 10-point moving average (corresponding to approximately 1.2 mm of build height) or a 15-point moving average (corresponding to approximately 1.5 mm of build height), may be applied to the laser power plan. The smoothed laser power recommendations may be further averaged over windows of build height, such as approximately 0.96 mm (24 layers) to approximately 4 mm (200 layers), to facilitate practical implementation. The layer-by-layer process plan 162 is communicated from the computing device 130 to the slicer software 118 of the LPBF system 100 for implementation during fabrication.

The microstructure prediction module 170 predicts one or more characteristics of the solidified microstructure of the part 110 based on a combination of sensor data and simulation-derived thermal history quantifiers. The microstructure prediction module 170 includes a sensor feature extractor 172, a simulation quantifier component 174, a machine learning model 176, and a predicted microstructure output 178.

The sensor feature extractor 172 receives sensor data from the sensor array 120 and extracts process signature features. In various implementations, the sensor feature extractor 172 extracts the end-of-cycle temperature (Tₑ) and its spatial standard deviation (σTₑ) from the LWIR thermal camera 122, and the mean meltpool intensity (Iₘ) and its spatial standard deviation (σIₘ) from the optical tomography sensor 124. The LWIR thermal camera 122 and the optical tomography sensor 124 capture complementary aspects of the LPBF process. The LWIR thermal camera 122 is responsive to part-level changes in thermal history caused by changes in part geometry, while the optical tomography sensor 124 captures variations in instantaneous, localized meltpool and hatch-level temperatures resulting from changes in processing parameters.

The simulation quantifier component 174 receives the thermal history quantifiers from the graph theory thermal model 140, including the predicted end-of-cycle temperature and the predicted cooling time.

The machine learning model 176 receives the sensor-derived features from the sensor feature extractor 172 and the simulation-derived quantifiers from the simulation quantifier component 174, and predicts one or more characteristics of the solidified microstructure. Combining both sensor-derived features and simulation-derived quantifiers as inputs (referred to herein as graybox modeling) couples multi-scale process phenomena: the sensor data captures real-time process stochasticity and surface-level thermal-fluid phenomena, while the simulation-derived quantifiers capture sub-surface thermal gradients and cooling rates that are not observable using in-situ sensors. In various implementations, the machine learning model 176 may include a k-nearest neighbors (kNN) model, although other machine learning algorithms, such as random forests, support vector machines, neural networks, or gradient boosting models, may be used. The machine learning model 176 may be implemented as a multiple-input single-output (MISO) model, in which a separate model is trained for each microstructure characteristic, or as a multiple-input multiple-output (MIMO) model, in which a single model predicts a plurality of microstructure characteristics simultaneously.

The machine learning model 176 is trained using ground-truth metallurgical characterization data obtained from post-process examination of previously fabricated parts. The ground-truth data may be obtained through techniques including optical microscopy, scanning electron microscopy (SEM), electron backscatter diffraction (EBSD), X-ray computed tomography (X-ray CT), and Vickers microhardness indentation. In various implementations, the machine learning model 176 may be trained using different categories of input features with ascending degrees of physics and sensor data fusion. For example, an empirical model (Category A) may use only the processing parameters (P, V) as inputs. A blackbox model (Category B) may use only the sensor-derived features (Tₑ, σTₑ, Iₙ, σIₘ) as inputs. A whitebox model (Category C) may use only the simulation-derived quantifiers as inputs. A graybox model (Category D) may combine the sensor-derived features and simulation-derived quantifiers (Categories B and C) as inputs. A full graybox model (Category E) may combine the processing parameters, sensor-derived features, and simulation-derived quantifiers (Categories A, B, and C) as inputs.

The predicted microstructure output 178 may include one or more of the following characteristics: a meltpool depth, a primary dendritic arm spacing, a grain aspect ratio, a grain major axis length, a standard deviation of grain orientation, a crystallographic texture ratio, and a microhardness. The meltpool depth is an indicator of process stability. The primary dendritic arm spacing is a measure of grain size and is correlated to mechanical properties including strength and fatigue resistance. The primary dendritic arm spacing is correlated to the cooling rate during solidification, with faster cooling rates producing finer dendritic structures (smaller PDAS) and slower cooling rates producing coarser dendritic structures (larger PDAS). Accordingly, controlling the thermal history to maintain a consistent cooling rate across layers of the part may reduce within-part variation in PDAS and thereby improve consistency of mechanical properties. The grain aspect ratio quantifies the degree of grain anisotropy, where equiaxed grains exhibit an aspect ratio approaching 1 and elongated columnar grains exhibit an aspect ratio significantly less than 1. The texture ratio quantifies the preferred crystallographic orientation along the build direction. In various implementations, the graybox models (Categories D and E) may achieve prediction accuracies in terms of the coefficient of determination (R²) exceeding approximately 90% to approximately 98%, compared to approximately 60% to approximately 85% for empirical, blackbox, or whitebox models.

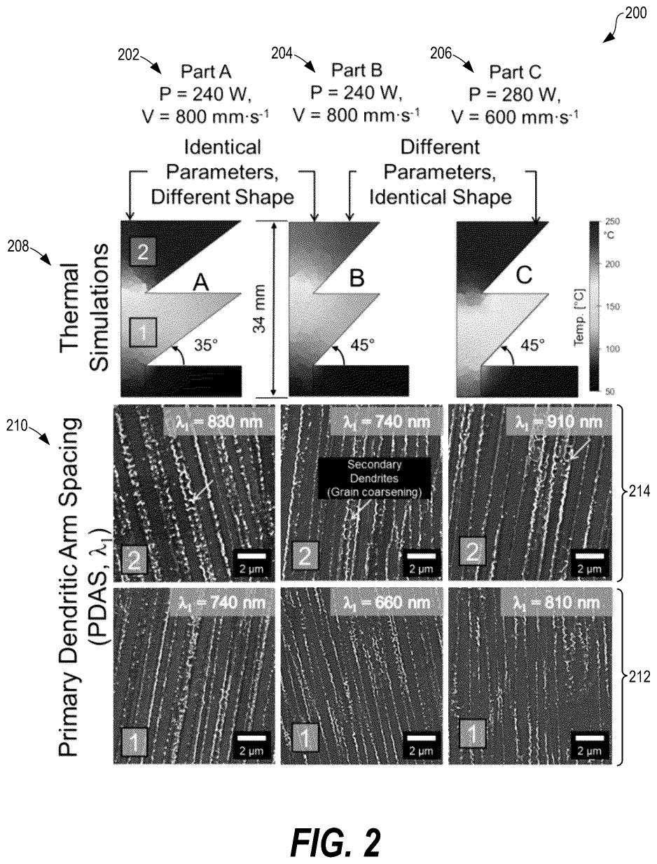

Turning to FIG. 2, shown is a comparison 200 of thermal simulation predictions and scanning electron microscopy (SEM) micrographs for three LPBF-processed Inconel 718 parts according to various implementations of the present disclosure. FIG. 2 illustrates how the solidified microstructure varies both within a part and between parts as a function of part geometry and processing conditions.

The comparison 200 includes a first part 202 (Part A), a second part 204 (Part B), and a third part 206 (Part C). The first part 202 and the second part 204 are fabricated under identical processing conditions of laser power P=240 W and scan velocity V=800 mm·s⁻¹. The first part 202 has an overhang angle of 350 and the second part 204 has an overhang angle of 45°. The third part 206 has the same 45° overhang angle as the second part 204 but is fabricated under different processing conditions of laser power P=280 W and scan velocity V=600 mm·s⁻¹. Each part is approximately 34 mm tall. Thus, the first part 202 and the second part 204 illustrate the effect of different geometry under identical parameters, while the second part 204 and the third part 206 illustrate the effect of different parameters under identical geometry.

Thermal simulation predictions 208 depict the predicted temperature distribution at the final layer for each of the first part 202, the second part 204, and the third part 206. The thermal simulations are generated using the graph theory thermal model described herein. As shown in the thermal simulation predictions 208, the first part 202 exhibits greater heat retention in the overhang region compared to the second part 204, despite being fabricated under identical processing conditions. This difference arises because the steeper 350 overhang angle of the first part 202 reduces the conductive pathway for heat to dissipate to the build plate relative to the 45° overhang angle of the second part 204. The third part 206 exhibits the greatest heat retention of the three parts due to the combination of the 45° overhang angle and increased energy input from the higher laser power and lower scan velocity.

SEM micrographs 210 show the primary dendritic arm spacing (PDAS, λ₁) measured at two locations on each part. A first location 212 is near the base of each part, and a second location 214 is near the top overhang region of each part. The PDAS is a measure of grain size, with larger PDAS values indicating coarser grain structure.

For the second part 204 (Part B), the PDAS at the first location 212 near the base is approximately 660 nm, and the PDAS at the second location 214 near the top is approximately 740 nm. The increase in PDAS from the base to the top of the part is a consequence of increased heat retention in the overhang region. For the first part 202 (Part A), fabricated under the same processing conditions but with a steeper overhang angle, the PDAS at the first location 212 is approximately 740 nm and the PDAS at the second location 214 is approximately 830 nm. Thus, the steeper overhang angle of the first part 202 intensifies heat retention and results in a coarser microstructure relative to the second part 204 at corresponding locations.

For the third part 206 (Part C), fabricated under increased energy density conditions, the PDAS at the first location 212 is approximately 810 nm and the PDAS at the second location 214 is approximately 910 nm. The increased heat retention in the third part 206 relative to the second part 204 results in a significantly coarser microstructure, despite the two parts having identical overhang angles. Secondary dendrites indicative of grain coarsening are visible in the SEM micrographs 210 for parts fabricated under conditions of elevated heat retention.

The observations from FIG. 2 illustrate that the solidified microstructure in LPBF is governed by the thermal history, which in turn is influenced by both the processing parameters and the part geometry. Processing parameters optimized for one geometry may not produce consistent microstructure when applied to a different geometry, and maintaining constant processing parameters throughout a part can result in within-part variation in grain size due to geometry-dependent changes in the thermal history between layers. In addition to microstructure heterogeneity, uneven temperature distributions in overhang regions can cause partially sintered powder particles to adhere to downward-facing surfaces, a phenomenon referred to as dross formation. Dross formation degrades the surface finish of external overhang surfaces and internal features that are inaccessible to post-process machining.

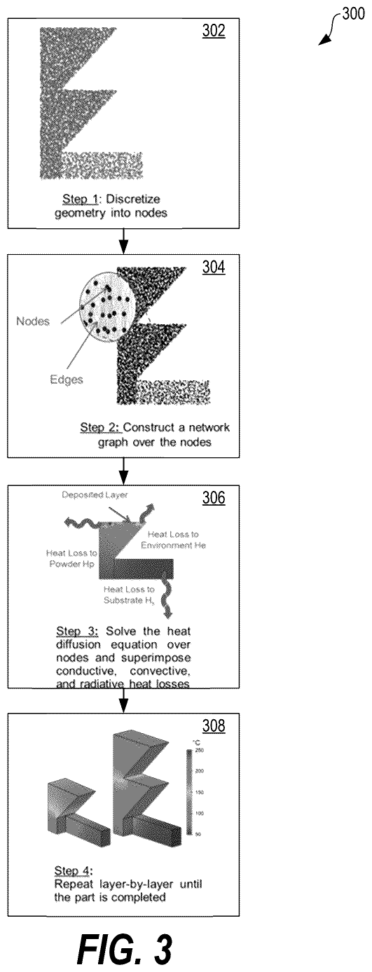

Turning to FIG. 3, shown is a schematic representation 300 of a graph theory thermal modeling approach for predicting the thermal history of an LPBF part according to various implementations of the present disclosure. The graph theory thermal modeling approach includes four steps, which are applied to predict the layer-wise temperature distribution of the part as a function of part geometry, material properties, and processing conditions.

At a first step 302, a digital representation of the part geometry, such as a CAD model, is discretized into a plurality of discrete spatial points, referred to as nodes. Each node represents a sampled location (x, y, z) within the volume of the part. The discretization replaces the continuous spatial domain of the part with a set of discrete points, eliminating the need for volumetric mesh generation that is typically required in finite element (FE) analysis. In various implementations, the node density may be in the range of approximately 1 node per cubic millimeter (nodes/mm³) to approximately 2.25 nodes/mm³.

At a second step 304, a network graph is constructed over the nodes from the first step 302. Each node is connected to adjacent nodes by edges that represent heat transfer pathways between neighboring spatial locations. The resulting network graph captures the geometric relationships between nodes and encodes the effect of part shape on heat diffusion. A discrete Laplacian matrix (L) is constructed from the network graph, and the eigenvalues (Λ) and eigenvectors (φ) of the Laplacian matrix are computed. The eigenvalues and eigenvectors represent the spatial modes of heat transfer within the part for a given layer. In various implementations, the eigenvalues and eigenvectors may be pre-computed for each layer of the part and stored in memory, such that the effect of different processing parameters on the thermal history can be evaluated without re-computing the spatial decomposition.

At a third step 306, the heat diffusion equation is solved over the nodes, and conductive, convective, and radiative heat losses at the boundaries of the part are superimposed. The heat losses include a heat loss to the substrate (Hₛ), a heat loss to the surrounding powder (Hₚ), and a heat loss to the build chamber environment (Hₑ). These heat losses are incorporated by augmenting the Laplacian matrix with type 3 (convection) boundary conditions. In the graph theory approach, the thermal history T(x, y, z, t) is expressed as a product of a part-shape-dependent term and a processing-condition-dependent term. The part-shape-dependent term is derived from the eigenvectors (φ), eigenvalues (Λ), and a cooling time (t), and includes a gain factor (g) that scales the cooling behavior. The processing-condition-dependent term is a function of the laser absorptivity (Aₑ), the scan path length per layer (Sₗ), the laser power (P), the scan velocity (V), the volume of material melted per layer (ν), and the temperature of the preceding layer. Because the part-shape-dependent term and the processing-condition-dependent term are decoupled, the thermal history can be rapidly iterated as a function of different processing parameter levels without re-computing the eigenvalues and eigenvectors of the Laplacian matrix.

At a fourth step 308, the third step 306 is repeated layer-by-layer until the thermal history for the entire part has been predicted. As each successive layer is deposited, the graph theory thermal model adds the corresponding nodes and edges, and updates the Laplacian matrix to reflect the evolving geometry. The output of the fourth step 308 is the complete predicted thermal history for the part, including the predicted end-of-cycle temperature and the predicted cooling time at each layer. In various implementations, the thermal history for a part may be predicted within approximately 1 minute to approximately 15 minutes on a desktop computing device, depending on the geometric complexity of the part.

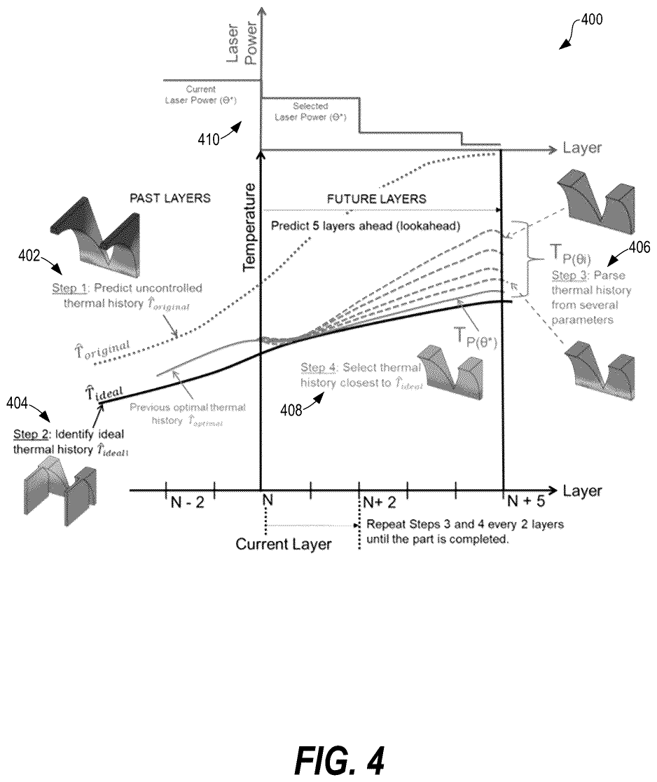

Turning to FIG. 4, shown is a schematic representation 400 of the model predictive control (MPC) approach implemented by the MPC controller 150 according to various implementations of the present disclosure. The schematic representation 400 depicts the temporal behavior of the MPC controller 150 at a current layer N of the part 110, illustrating how the processing parameters are iteratively optimized over a series of future layers.

In a first step (Predict), the graph theory thermal model 140 predicts the thermal history of the part 110 under nominal processing conditions. The resulting original thermal history 402 represents the predicted end-of-cycle temperature as a function of layer number when the processing parameters are maintained constant at manufacturer-recommended settings. As shown in FIG. 4, the original thermal history 402 may exhibit an increasing temperature trend in later layers, indicating heat accumulation that can cause microstructure heterogeneity and other thermal-induced defects.

In a second step (Identify), an ideal thermal history 404 is determined based on a control strategy selected by the control strategy selector 160. The ideal thermal history 404 represents the target end-of-cycle temperature trend that the MPC controller 150 strives to achieve by adjusting the processing parameters. As shown in FIG. 4, the ideal thermal history 404 may be a more uniform temperature trend that mitigates the heat accumulation observed in the original thermal history 402. In various implementations, the ideal thermal history 404 may be determined according to one of a plurality of control strategies, as described in further detail with reference to FIG. 6.

In a third step (Parse), the graph theory thermal model 140 predicts the thermal history of the part 110 over a prediction horizon of k future layers as a function of a plurality of candidate processing parameter levels. As shown in FIG. 4, the prediction horizon extends from the current layer N to layer N+5, corresponding to a lookahead of k=5 simulated layers. The resulting candidate thermal histories 406 represent the predicted end-of-cycle temperature trends for each of the h candidate laser power levels P(θᵢ), where i={1 . . . h}. As shown in FIG. 4, the candidate thermal histories 406 fan out over the prediction horizon, with each curve corresponding to a different candidate laser power level.

In a fourth step (Select), the MPC controller 150 selects the candidate laser power level θ* that results in the candidate thermal history closest to the ideal thermal history 404 over the prediction horizon. The selected thermal history 408 represents the predicted end-of-cycle temperature trend corresponding to the selected laser power level θ*. As shown in FIG. 4, the selected thermal history 408 is the candidate thermal history among the candidate thermal histories 406 that minimizes the mean absolute deviation from the ideal thermal history 404 over the k future layers.

The third step (Parse) and the fourth step (Select) can be repeated at intervals of a control horizon, such as approximately every 2 simulated layers (e.g., from layer N to layer N+2). At each control horizon, the MPC controller 150 advances to the next set of layers and repeats the Parse and Select steps over a new prediction horizon. This iterative process continues until the processing parameters have been determined for every layer of the part 110.

FIG. 4 depicts a laser power adjustment corresponding to the layer-by-layer laser power plan 410. As shown, the laser power is maintained at a current level for layers preceding the current layer N and is adjusted to a selected level determined by the Select step for layers following the current layer N. As the Parse and Select steps are repeated at each control horizon, the laser power may be adjusted at successive intervals, resulting in the complete layer-by-layer laser power plan 410 for the entire part 110. The layer-by-layer laser power plan 410 corresponds to the process plan 162 described with reference to FIG. 1 and is communicated to the slicer software 118 for implementation during fabrication.

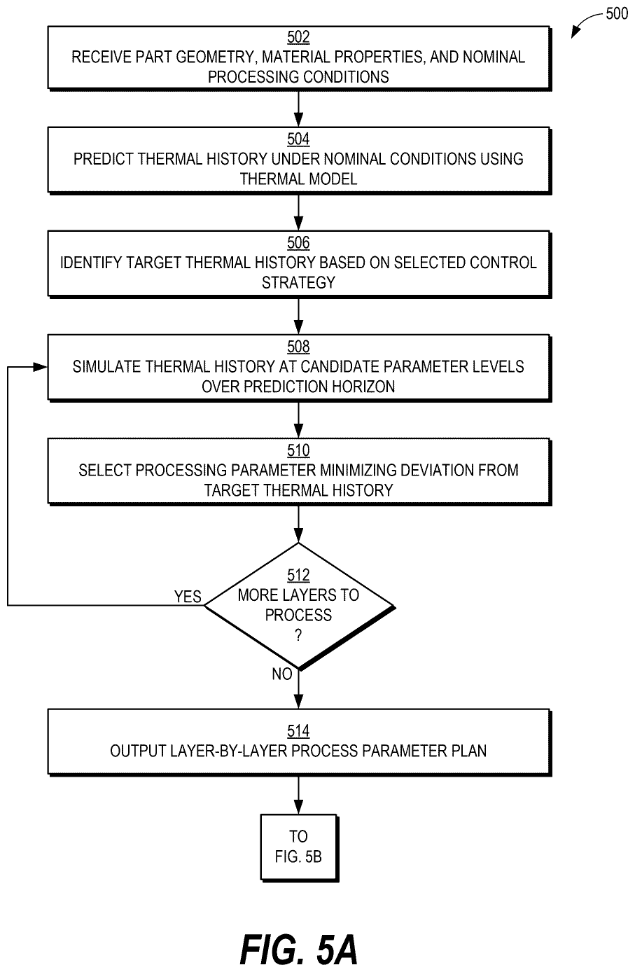

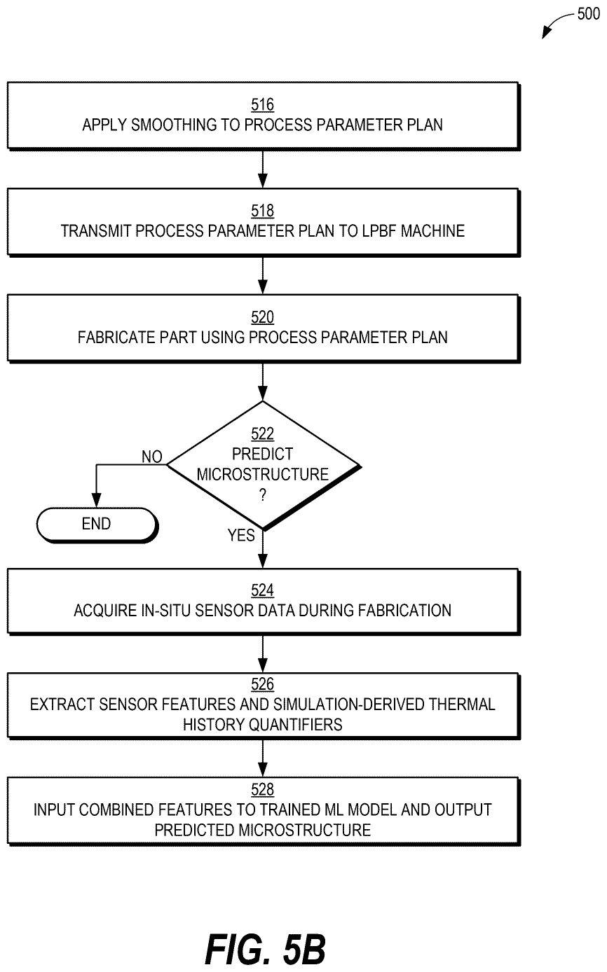

Turning to FIGS. 5A and 5B, shown is a flowchart of a method 500 for physics-guided thermal history control and microstructure prediction in laser powder bed fusion according to various implementations of the present disclosure. The method 500 may be performed by the computing device 130 described with reference to FIG. 1.

At block 502, the computing device 130 receives a digital representation of a part geometry, material properties of the metallic powder material, and nominal processing conditions. The digital representation may include a CAD model of the part 110. The nominal processing conditions may include manufacturer-recommended settings for laser power, scan velocity, hatch spacing, and layer thickness.

At block 504, the computing device 130 predicts the thermal history of the part 110 under the nominal processing conditions using the graph theory thermal model 140. The graph theory thermal model 140 discretizes the part geometry into nodes, constructs a Laplacian matrix, computes the eigenvalues and eigenvectors, and predicts the layer-wise end-of-cycle temperature and cooling time as described with reference to FIG. 3. The predicted thermal history under nominal conditions is the original thermal history.

At block 506, the computing device 130 identifies a target thermal history based on a control strategy selected by the control strategy selector 160. The target thermal history represents the desired end-of-cycle temperature trend that the MPC controller 150 strives to achieve. In various implementations, the control strategy may include maintaining a constant end-of-cycle temperature, minimizing a spatial temperature gradient between layers, maintaining a constant cooling rate, maintaining a constant interlayer time, or matching the thermal history of a reference part fabricated with support structures, as described in further detail with reference to FIG. 6.

At block 508, the computing device 130 simulates the thermal history of the part 110 over a prediction horizon of k future layers as a function of a plurality of candidate processing parameter levels using the graph theory thermal model 140. Because the eigenvalues and eigenvectors of the Laplacian matrix are pre-computed, the computing device 130 can evaluate the thermal history at each candidate processing parameter level without re-computing the spatial decomposition.

At block 510, the computing device 130 selects the candidate processing parameter that minimizes the deviation of the predicted thermal history from the target thermal history over the prediction horizon. In various implementations, the computing device 130 selects the laser power level that minimizes the mean absolute deviation between the predicted thermal history and the target thermal history over the k future layers.

At decision block 512, the method 500 determines whether additional layers of the part 110 remain to be processed. If additional layers remain, the method 500 returns to block 508, advances the layer counter by the control horizon (e.g., 2 simulated layers), and repeats blocks 508 and 510 over a new prediction horizon. If no additional layers remain, the method 500 proceeds to block 514.

At block 514, the computing device 130 outputs the layer-by-layer process parameter plan specifying the processing parameters for each layer or group of layers of the part 110.

Referring now to FIG. 5B, at block 516, the computing device 130 applies a smoothing operation to the layer-by-layer process parameter plan to reduce abrupt changes in laser power between adjacent layers. In various implementations, the smoothing operation may include applying a moving average filter, such as a 10-point moving average corresponding to approximately 1.2 mm of build height or a 15-point moving average corresponding to approximately 1.5 mm of build height. The smoothed laser power recommendations may be further averaged over windows of build height, such as approximately 0.96 mm to approximately 4 mm, to facilitate practical implementation.

At block 518, the computing device 130 transmits the smoothed process parameter plan to the slicer software 118 of the LPBF system 100 for implementation during fabrication.

At block 520, the LPBF system 100 fabricates the part 110 using the process parameter plan. The machine controller 116 controls the laser assembly 104, the galvanometric mirrors 106, and the recoater 114 in accordance with the machine-executable instructions generated by the slicer software 118 from the process parameter plan.

At decision block 522, the method 500 determines whether to predict one or more characteristics of the solidified microstructure of the part 110. If microstructure prediction is not performed, the method 500 ends. If microstructure prediction is performed, the method 500 proceeds to block 524.

At block 524, the sensor array 120 acquires in-situ sensor data during fabrication of the part 110. In various implementations, the LWIR thermal camera 122 acquires thermal images from which the end-of-cycle temperature (Tₑ) and its spatial standard deviation (σTₑ) are extracted, and the optical tomography sensor 124 acquires meltpool intensity data from which the mean meltpool intensity (Iₘ) and its spatial standard deviation (σIₘ) are extracted. In various implementations, the sensor data may be acquired concurrently with the fabrication at block 520.

At block 526, the computing device 130 extracts sensor-derived features from the sensor data acquired at block 524 and simulation-derived thermal history quantifiers from the graph theory thermal model 140, including the predicted end-of-cycle temperature and the predicted cooling time.

At block 528, the computing device 130 inputs the combined sensor-derived features and simulation-derived thermal history quantifiers to the machine learning model 176 trained on ground-truth metallurgical characterization data. The machine learning model 176 outputs one or more predicted microstructure characteristics of the part 110, which may include a meltpool depth, a primary dendritic arm spacing, a grain aspect ratio, a grain major axis length, a standard deviation of grain orientation, a crystallographic texture ratio, and a microhardness.

Turning to FIGS. 6A and 6B, shown is an implementation of a constant end-of-cycle temperature control strategy (KTₑ) 600A and 600B for a cone-shaped part according to various implementations of the present disclosure. The constant end-of-cycle temperature strategy is one of a plurality of control strategies that may be selected by the control strategy selector 160 to determine the target thermal history in the identify component 154 of the MPC controller 150.

FIG. 6A depicts the predicted end-of-cycle temperature (\hat{T}ₑ) as a function of build height and layer number for the cone-shaped part under three scenarios: an uncontrolled scenario, an ideal or target thermal history, and a controlled scenario implementing the constant end-of-cycle temperature strategy. In the uncontrolled scenario (U), the laser power is maintained constant at P=230 W for all layers, and the resulting uncontrolled thermal history (\hat{T}_{original}) exhibits significant heat accumulation, with the end-of-cycle temperature rising from approximately 80° C. near the base to approximately 200° C. near a build height of approximately 12 mm. The heat accumulation is a consequence of the changing cross-section of the cone-shaped part and the corresponding reduction in interlayer time.

The ideal thermal history (\hat{T}_{ideal}) for the constant end-of-cycle temperature strategy is set as an upper bound on the end-of-cycle temperature. In various implementations, the upper bound may be set on a per-part basis, such as the average of the uncontrolled end-of-cycle temperature over the entire part. For the cone-shaped part, the target end-of-cycle temperature is approximately 110° C. The laser power is reduced by the MPC controller 150 only when the predicted end-of-cycle temperature increases above the target; excursions below the target are not corrected by the controller.

The controlled thermal history (KTₑ) shown in FIG. 6A demonstrates that the constant end-of-cycle temperature strategy significantly mitigates the peak end-of-cycle temperature relative to the uncontrolled scenario. The controlled end-of-cycle temperature remains closer to the target throughout the build, although exact matching is not achieved due to the constraints placed on the adjustable levels of laser power.

FIG. 6B depicts the layer-by-layer laser power adjustments recommended by the MPC controller 150 for the constant end-of-cycle temperature strategy. The laser power is constrained between approximately 182 W and approximately 245 W to avoid lack-of-fusion porosity at the lower bound and keyhole porosity at the upper bound. In the uncontrolled scenario (U), the laser power is maintained constant at P=230 W for all layers. Under the constant end-of-cycle temperature strategy (KTₑ), the MPC controller 150 maintains the nominal laser power for early layers and initiates a reduction in laser power at approximately 12.5 mm of build height (approximately 312 layers), where the predicted end-of-cycle temperature begins to exceed the target. The laser power is reduced progressively to the lower constraint of approximately 182 W to counteract the heat accumulation in the later layers of the cone-shaped part.

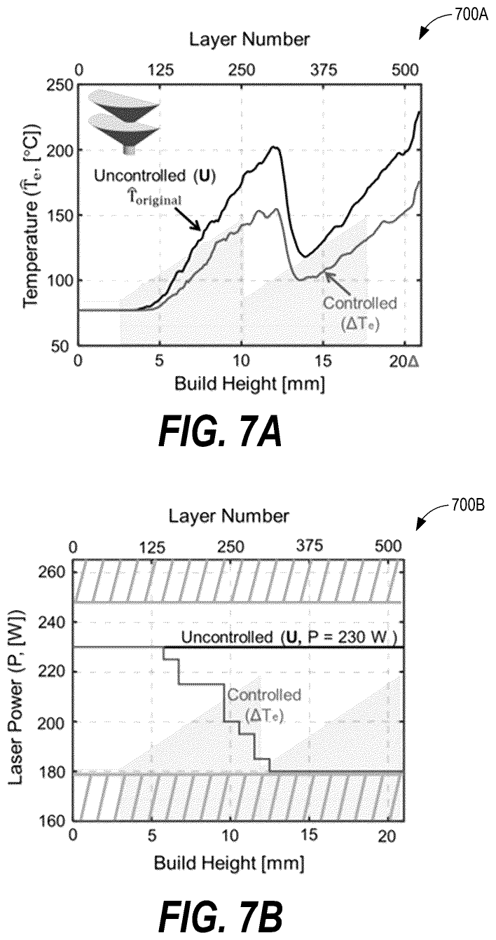

Turning to FIGS. 7A and 7B, shown is an implementation of an end-of-cycle temperature gradient minimization control strategy (ΔTₑ) 700A, 700B for the cone-shaped part according to various implementations of the present disclosure. The gradient minimization strategy is another of the plurality of control strategies that may be selected by the control strategy selector 160.

FIG. 7A depicts the predicted end-of-cycle temperature (\hat{T}ₑ) as a function of build height and layer number for the cone-shaped part under the uncontrolled scenario (U) and the controlled scenario implementing the gradient minimization strategy (ΔTₑ). In the uncontrolled scenario, the laser power is maintained constant at P=230 W, and the resulting uncontrolled thermal history (\hat{T}_{original}) exhibits the same heat accumulation pattern described with reference to FIG. 6A.

The gradient minimization strategy (ΔTₑ) aims to minimize positive spatial gradients in the end-of-cycle temperature between layers. Sharp increases in temperature between layers can result in flaws such as cracking, thermal-induced distortion, and recoater crashes. In various implementations, the spatial temperature gradient is estimated by averaging the slopes of the predicted end-of-cycle temperature from the present layer to k future layers (e.g., 5 future layers). Positive slopes exceeding a threshold, such as approximately 1° C. per layer, are identified for mitigation by reducing the laser power. The ideal spatial temperature gradient may be approximately 0° C. per layer.

The controlled thermal history (ΔTₑ) shown in FIG. 7A demonstrates that the gradient minimization strategy significantly reduces the peak end-of-cycle temperature relative to the uncontrolled scenario. Compared to the constant end-of-cycle temperature strategy (KTₑ) described with reference to FIG. 6A, the gradient minimization strategy initiates a control response earlier in the build, thereby preemptively mitigating the anticipated temperature rise.

FIG. 7B depicts the layer-by-layer laser power adjustments recommended by the MPC controller 150 for the gradient minimization strategy. The laser power is constrained between approximately 182 W and approximately 245 W. Under the gradient minimization strategy (ΔTₑ), the MPC controller 150 initiates a reduction in laser power at approximately 6 mm of build height (approximately 150 layers), which is earlier than the approximately 12.5 mm of build height at which the constant end-of-cycle temperature strategy (KTₑ) begins adjusting the laser power as described with reference to FIG. 6B. The earlier onset of laser power reduction under the gradient minimization strategy reflects the controller responding to the anticipated rate of temperature increase rather than waiting for the temperature to exceed an absolute threshold.

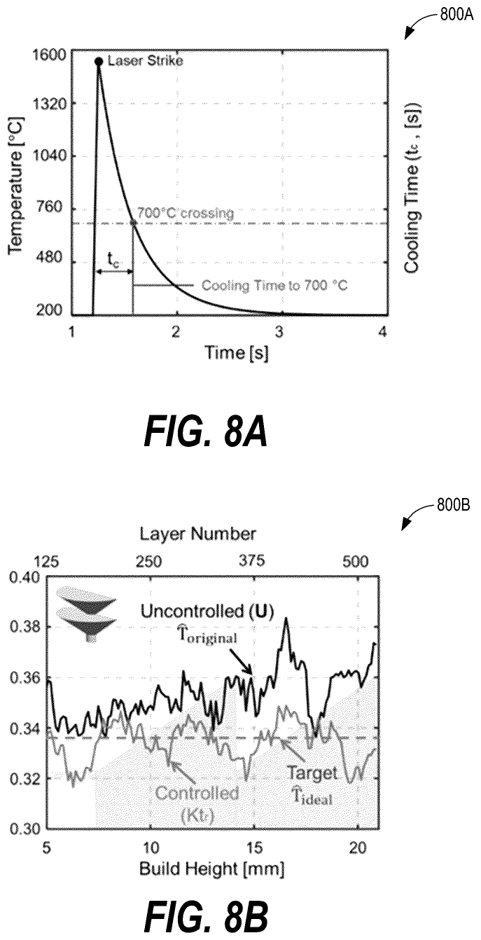

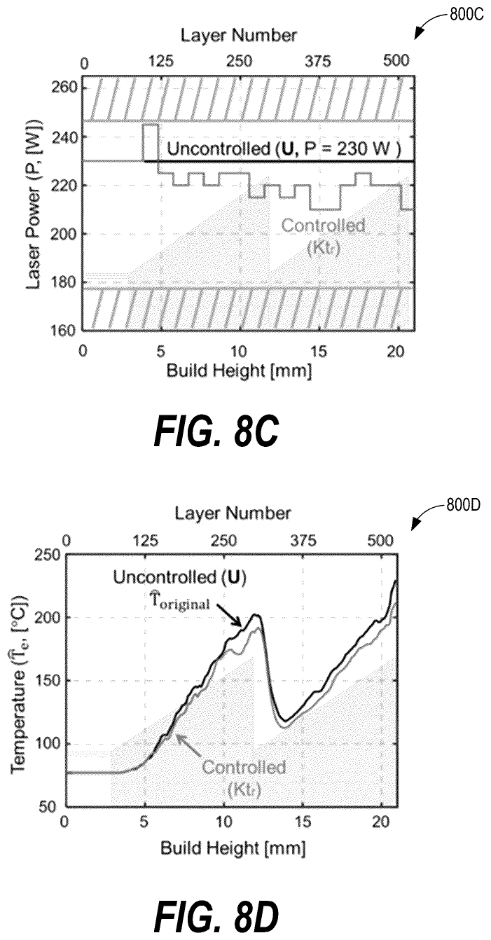

Turning to FIGS. 8A through 8D, shown is an implementation of a constant cooling rate control strategy (Ktᵣ) 800A, 800B, 800C, 800D for the cone-shaped part according to various implementations of the present disclosure. The constant cooling rate strategy is another of the plurality of control strategies that may be selected by the control strategy selector 160.

FIG. 8A depicts a cooling curve predicted by the graph theory thermal model 140 for a single layer of the cone-shaped part. The cooling curve shows the predicted temperature as a function of time following a laser strike. The peak of the cooling curve corresponds to the temperature at the instant of the laser strike, which rapidly decays toward the end-of-cycle temperature. The cooling time (t_{c}) is defined as the duration for the temperature to decay from the peak temperature to a threshold temperature of approximately 700° C., representing approximately one-half the liquidus temperature of the metallic powder material. As described with reference to FIG. 8A, the cooling time (t_{c}) is the inverse of the cooling rate and is the thermal history metric controlled by the constant cooling rate strategy.

FIG. 8B depicts the predicted cooling time (t_{c}) as a function of build height and layer number for the cone-shaped part under the uncontrolled scenario (U) and the controlled scenario implementing the constant cooling rate strategy (Ktᵣ). In the uncontrolled scenario, the cooling time (\hat{T}_{original}) fluctuates between approximately 0.34 seconds and approximately 0.38 seconds as the part geometry changes between layers. The target cooling time (\hat{T}_{ideal}) for the constant cooling rate strategy is set as a weighted average of the minimum and maximum predicted cooling time for the uncontrolled scenario. For the cone-shaped part, the target cooling time is approximately 0.335 seconds. In various implementations, cooling times estimated for the first approximately 5 mm of build height may be excluded from the target calculation, as the build plate acts as a heat sink that rapidly conducts heat in the base layers and biases the cooling time trends. The controlled cooling time (Ktᵣ) shown in FIG. 8B restricts the variation in cooling time to within approximately ±0.01 seconds of the target. Unlike the constant end-of-cycle temperature strategy (KTₑ) and the gradient minimization strategy (ΔTₑ) described with reference to FIGS. 6A and 7A, the constant cooling rate controller activates when the predicted cooling time either exceeds or falls below the target.

FIG. 8C depicts the layer-by-layer laser power adjustments recommended by the MPC controller 150 for the constant cooling rate strategy. The laser power is constrained between approximately 182 W and approximately 245 W. Under the constant cooling rate strategy (Ktᵣ), the laser power fluctuates between layers to maintain the cooling time near the target value, in contrast to the more monotonic power reductions observed under the constant end-of-cycle temperature strategy (KTₑ) shown in FIG. 6B and the gradient minimization strategy (ΔTₑ) shown in FIG. 7B.

FIG. 8D depicts the predicted end-of-cycle temperature (\hat{T}ₑ) as a function of build height and layer number for the cone-shaped part under the uncontrolled scenario (U) and the controlled scenario implementing the constant cooling rate strategy (Ktᵣ). As shown in FIG. 8D, there is not a significant difference in the end-of-cycle temperature between the uncontrolled and controlled scenarios. This is because the constant cooling rate strategy adjusts the laser power to maintain a constant cooling time rather than to reduce the end-of-cycle temperature directly, and the resulting laser power adjustments do not deviate substantially from the nominal laser power.

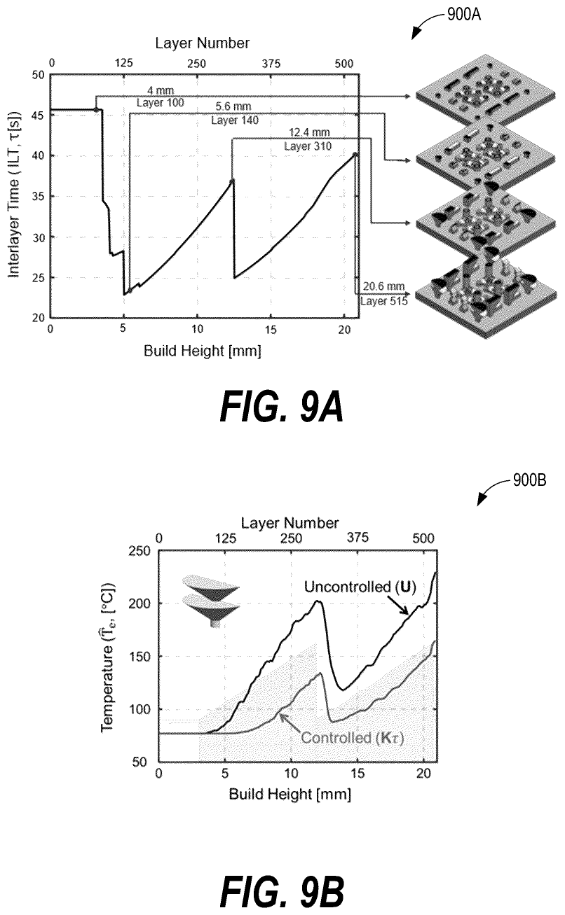

Turning to FIGS. 9A and 9B, shown is an implementation of a constant interlayer time control strategy (Kτ) 900A, 900B for the cone-shaped part according to various implementations of the present disclosure. The constant interlayer time strategy is another of the plurality of control strategies that may be selected by the control strategy selector 160. Unlike the constant end-of-cycle temperature strategy (KTₑ), the gradient minimization strategy (ΔTₑ), and the constant cooling rate strategy (Ktᵣ), which adjust the laser power through the MPC controller 150, the constant interlayer time strategy adjusts the time between layers without modifying the laser power.

FIG. 9A depicts the interlayer time (ILT, τ) as a function of build height and layer number for the build plate used to fabricate the cone-shaped part. The interlayer time is the duration between the start of melting of a location on a preceding layer and the start of scanning of the same location on a succeeding layer. The interlayer time encompasses the time required for the recoater 114 to deposit a layer of powder (e.g., approximately 10 seconds) and the time required for the laser to scan the layer, which varies proportionally to the surface area that melted at each layer. Build plate cross-sections at various build heights are shown in FIG. 9A, illustrating how the total cross-sectional area of the parts changes as layers are deposited. At the start of the build (e.g., approximately 4 mm, layer 100), the cross-sectional area is relatively large, and the interlayer time is approximately 45.6 seconds per layer. The interlayer time reduces to approximately 22 seconds at approximately 5.6 mm of build height (layer 140) as the broad base sections of the parts are completed and the total cross-sectional area decreases. The interlayer time then gradually increases to approximately 37 seconds at approximately 12.4 mm of build height (layer 310) before dropping sharply to approximately 22 seconds at approximately 20.6 mm of build height (layer 515). A shorter interlayer time reduces the cooling duration between layers and exacerbates heat retention, which can result in grain coarsening, geometric distortion, and recoater crashes. A longer interlayer time allows additional cooling between layers and reduces heat retention.

To maintain a constant interlayer time, a virtual part, sometimes referred to as a ghost part, may be added to the build plate and scanned at a laser power of approximately 0 W. The cross-sectional area of the virtual part is varied layer-by-layer such that the total scan area across all parts on the build plate, and consequently the interlayer time, remains constant. For the cone-shaped part, the constant interlayer time is set to τ=57 seconds across all layers, which is approximately 1.25 times the maximum interlayer time of approximately 45.6 seconds observed for the uncontrolled build plate shown in FIG. 9A.

FIG. 9B depicts the predicted end-of-cycle temperature (\hat{T}ₑ) as a function of build height and layer number for the cone-shaped part under the uncontrolled scenario (U) and the controlled scenario implementing the constant interlayer time strategy (Kτ). As shown in FIG. 9B, the constant interlayer time strategy significantly reduces the peak end-of-cycle temperature relative to the uncontrolled scenario. For the uncontrolled scenario, the end-of-cycle temperature rises from approximately 80° C. near the base to over approximately 200° C. Under the constant interlayer time strategy, the peak end-of-cycle temperature is reduced to approximately 150° C.

The constant interlayer time strategy has the advantage of not requiring changes to the processing parameters through the MPC controller 150 and not requiring thermal simulations to generate the process plan. All processing conditions apart from the interlayer time are maintained identical to the uncontrolled scenario. However, increasing the interlayer time increases the total build time. For the cone-shaped part, the build time increased from approximately 5 hours under the uncontrolled scenario to approximately 8 hours under the constant interlayer time strategy. Further, the constant interlayer time strategy does not account for differences in shape between individual parts on the build plate, and does not specifically address localized thermal effects at features such as steep overhangs and thin walls.

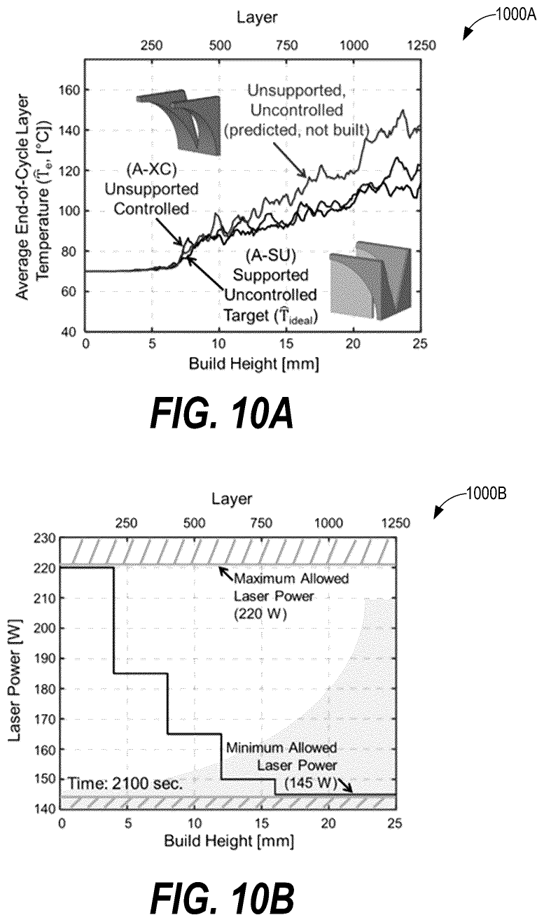

Turning to FIGS. 10A and 10B, shown is an implementation of a support-matching control strategy 1000A, 1000B for an arch-shaped part according to various implementations of the present disclosure. The support-matching strategy is another of the plurality of control strategies that may be selected by the control strategy selector 160. Under the support-matching strategy, the target thermal history (\hat{T}_{ideal}) is the predicted thermal history of a corresponding part fabricated with support structures, and the MPC controller 150 adjusts the laser power such that a part fabricated without support structures achieves a comparable thermal history.

FIG. 10A depicts the average end-of-cycle layer temperature (\hat{T}ₑ) as a function of build height and layer number for the arch-shaped part under three scenarios. A first scenario is an unsupported, uncontrolled arch in which the laser power is maintained constant and no support structures are present. The first scenario is a hypothetical prediction that was not physically built because the predicted heat accumulation in the overhang region would result in overheating and a recoater crash. A second scenario is a supported, uncontrolled arch (A-SU) in which the laser power is maintained constant and solid support material is added underneath the overhang. The support structures provide a thermal pathway to conduct heat away from the overhang region to the build plate 112, resulting in a more uniform thermal history. The thermal history of the supported, uncontrolled arch (A-SU) is selected as the target thermal history (\hat{T}_{ideal}) for the support-matching strategy. A third scenario is an unsupported, controlled arch (A-XC) in which no support structures are present, but the laser power is adjusted layer-by-layer by the MPC controller 150 such that the thermal history of the unsupported arch matches the thermal history of the supported arch (A-SU).

As shown in FIG. 10A, the unsupported, uncontrolled scenario exhibits significant heat accumulation in the overhang region, with the end-of-cycle temperature exceeding approximately 160° C. The supported, uncontrolled arch (A-SU) maintains a lower end-of-cycle temperature, in the range of approximately 60° C. to approximately 100° C., due to the conductive pathway provided by the support structures. The unsupported, controlled arch (A-XC) closely matches the thermal history of the supported arch (A-SU), demonstrating that the MPC controller 150 can replicate the thermal benefits of support structures through layer-by-layer adjustment of the laser power without requiring the physical presence of support structures.

FIG. 10B depicts the layer-by-layer laser power adjustments recommended by the MPC controller 150 for the unsupported, controlled arch (A-XC). The laser power is constrained between a minimum allowed laser power of approximately 145 W and a maximum allowed laser power of approximately 220 W to avoid lack-of-fusion porosity at the lower bound and keyhole porosity at the upper bound. As shown in FIG. 10B, the MPC controller 150 progressively reduces the laser power from the nominal value as the overhang region of the arch is reached, reducing the laser power toward the minimum constraint of approximately 145 W to counteract the heat accumulation caused by the absence of support structures. The computation time for the MPC controller 150 to generate the complete process parameter plan for the arch-shaped part was approximately 2100 seconds (approximately 35 minutes).

The support-matching strategy enables fabrication of parts with overhang features without support structures while maintaining comparable thermal history, microstructure, and geometric integrity to corresponding supported parts. Elimination of support structures can reduce post-processing machining time, material usage, and manufacturing cost. In various implementations, the support-matching strategy may also prevent recoater crashes in parts with steep overhang features that would otherwise fail when fabricated under constant processing conditions without support structures.

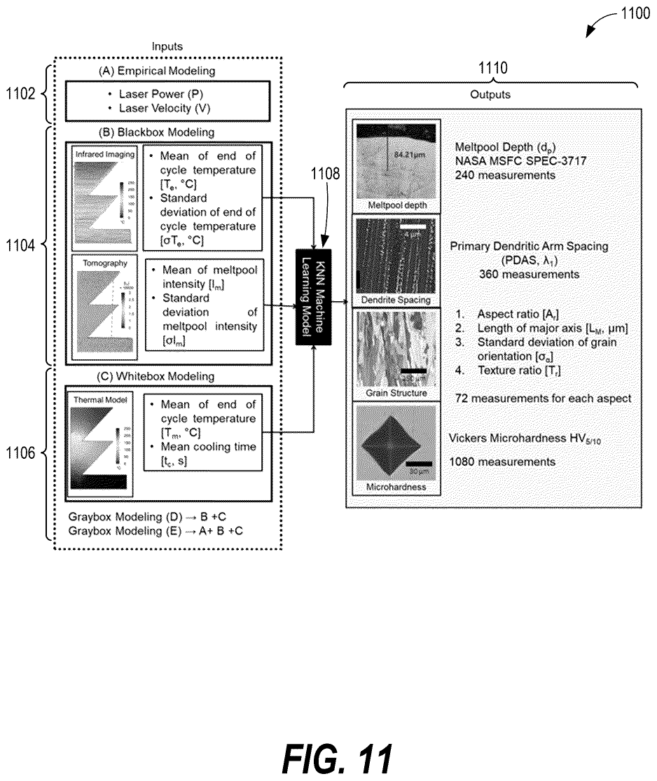

Turning to FIG. 11, shown is a schematic representation 1100 of the microstructure prediction framework implemented by the microstructure prediction module 170 according to various implementations of the present disclosure. The prediction framework 1100 depicts the input features, model categories, and predicted microstructure outputs.

The prediction framework 1100 includes three categories of input features. Processing parameter inputs 1102 include the laser power (P) and the scan velocity (V). Sensor-derived inputs 1104 include features extracted from the in-situ sensor array 120: the mean end-of-cycle temperature (Tₑ) and its spatial standard deviation (σTₑ) acquired from the LWIR thermal camera 122, and the mean meltpool intensity (Iₘ) and its spatial standard deviation (σIₘ) acquired from the optical tomography sensor 124. Simulation-derived inputs 1106 include thermal history quantifiers predicted by the graph theory thermal model 140: the predicted mean end-of-cycle temperature (\hat{T}ₑ) and the predicted mean cooling time (\hat{t}_{c}).

The prediction framework 1100 defines five model categories with ascending degrees of physics and sensor data fusion. A first model category (Category A) uses only the processing parameter inputs 1102 as an empirical baseline. A second model category (Category B) uses only the sensor-derived inputs 1104, representing a blackbox, data-driven approach. A third model category (Category C) uses only the simulation-derived inputs 1106, representing a whitebox, physics-based approach. A fourth model category (Category D) combines the sensor-derived inputs 1104 and the simulation-derived inputs 1106, representing a graybox approach that fuses real-time sensor data with physics-based thermal modeling. A fifth model category (Category E) combines the processing parameter inputs 1102, the sensor-derived inputs 1104, and the simulation-derived inputs 1106, representing a full graybox approach.

The input features from the selected model category are provided to a machine learning model 1108. In various implementations, the machine learning model 1108 may include a k-nearest neighbors (kNN) model. The machine learning model 1108 may be implemented as a multiple-input single-output (MISO) model, in which a separate model is trained for each microstructure characteristic, or as a multiple-input multiple-output (MIMO) model, in which a single model predicts a plurality of microstructure characteristics simultaneously. The machine learning model 1108 is trained using ground-truth metallurgical characterization data obtained from post-process examination of previously fabricated parts.

The machine learning model 1108 outputs predicted microstructure characteristics 1110. The predicted microstructure characteristics 1110 may include one or more of: a meltpool depth (dₚ), measured by optical microscopy (e.g., 240 measurements across 12 parts); a primary dendritic arm spacing (λ₁), measured by scanning electron microscopy (e.g., 360 measurements across 12 parts); grain structure characteristics including a grain aspect ratio (Aᵣ), a length of major axis (Lₘ), a standard deviation of grain orientation (σₐ), and a texture ratio (Tᵣ), measured by electron backscatter diffraction (e.g., 72 measurements for each characteristic across 12 parts); and a microhardness (HV), measured by Vickers indentation (e.g., 1080 measurements across 12 parts).

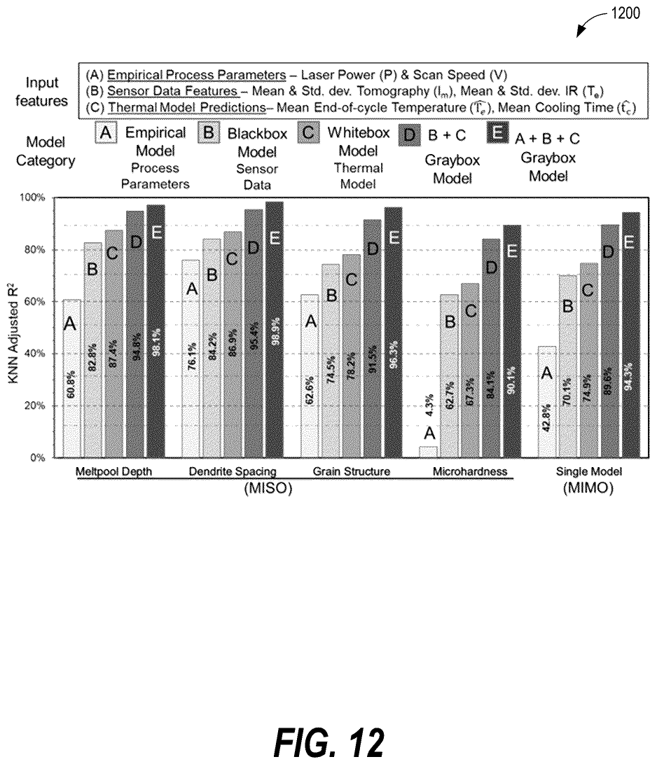

Turning to FIG. 12, shown is a comparison 1200 of prediction accuracy for the machine learning model 1108 across the model categories and microstructure characteristics according to various implementations of the present disclosure. The prediction accuracy is quantified in terms of the adjusted coefficient of determination (R²).

As shown in FIG. 12, the graybox models (Categories D and E) increasingly outperform the empirical (Category A), blackbox (Category B), and whitebox (Category C) models as the scale of the microstructure characteristic decreases from meltpool depth (dₚ) to primary dendritic arm spacing (λ₁) to grain structure to microhardness (HV).

For the meltpool depth (dₚ), the empirical model (Category A) achieves a prediction accuracy of R² of approximately 60%. The blackbox model (Category B), using only sensor-derived features, achieves R² of approximately 82%. The whitebox model (Category C), using only simulation-derived quantifiers, achieves R² of approximately 87%. The graybox model (Category D), combining sensor-derived features and simulation-derived quantifiers, achieves R² of approximately 95%. The full graybox model (Category E), further incorporating processing parameters, achieves R² of approximately 98%.

For the microhardness (HV), the empirical model (Category A) achieves a prediction accuracy of R² of less than approximately 5%, indicating that processing parameters alone are not predictive of microhardness. The prediction accuracy using either sensor-derived features (Category B) or simulation-derived quantifiers (Category C) is approximately 65%. The graybox models (Categories D and E) improve the prediction accuracy to approximately 90% or greater.

In general, the fusion of sensor-derived features and simulation-derived thermal history quantifiers in the graybox models (Categories D and E) achieves prediction accuracies in the range of approximately 90% to approximately 98%, compared to approximately 60% to approximately 85% for empirical, blackbox, or whitebox models. Further, a single multiple-input multiple-output (MIMO) graybox model achieves R² of approximately 98%, compared to R² in the range of approximately 45% to approximately 75% for empirical, blackbox, and whitebox MIMO models.

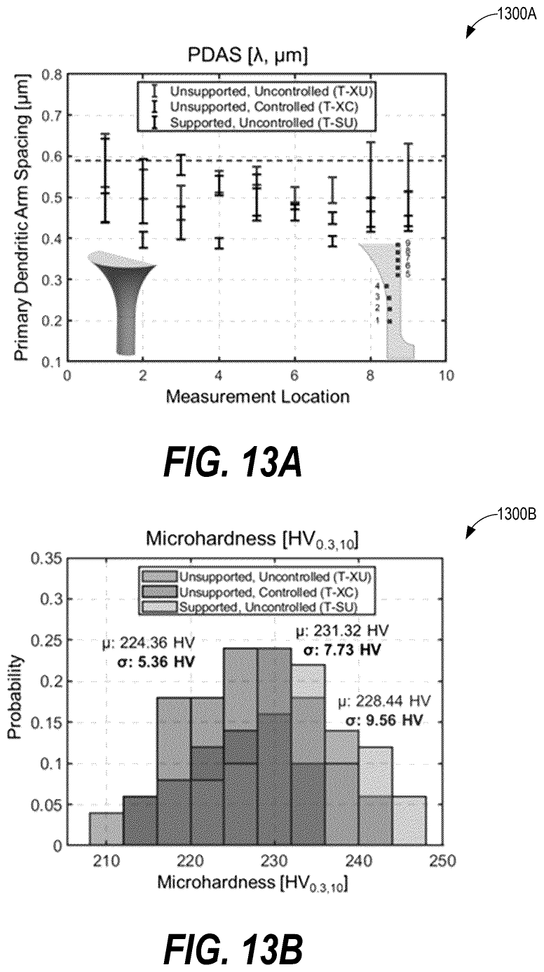

Turning to FIGS. 13A and 13B, shown is a comparison of the primary dendritic arm spacing and microhardness for the trumpet-shaped part according to various implementations of the present disclosure. FIGS. 13A and 13B illustrate the effect of the support-matching control strategy on the solidified microstructure and a functional property of the part.

FIG. 13A depicts the primary dendritic arm spacing (PDAS, λ₁) 1300A measured at nine locations along the build height for three trumpet-shaped parts: an unsupported, uncontrolled trumpet (T-XU) fabricated under constant laser power without support structures; a supported, uncontrolled trumpet (T-SU) fabricated under constant laser power with support structures; and an unsupported, controlled trumpet (T-XC) fabricated without support structures but with layer-by-layer laser power adjustments recommended by the MPC controller 150 using the support-matching strategy described with reference to FIGS. 10A and 10B. The target thermal history for the unsupported, controlled trumpet (T-XC) is the thermal history of the supported, uncontrolled trumpet (T-SU).

As shown in FIG. 13A, the PDAS for the unsupported, uncontrolled trumpet (T-XU) ranges from approximately 500 nm to approximately 690 nm across the nine measurement locations, indicating significant within-part variation in grain size due to the uneven thermal history. The PDAS for the supported, uncontrolled trumpet (T-SU) ranges from approximately 390 nm to approximately 690 nm. By contrast, the PDAS for the unsupported, controlled trumpet (T-XC) ranges from approximately 350 nm to approximately 400 nm, indicating substantially reduced within-part grain size variation. The reduced PDAS and narrower PDAS range for the unsupported, controlled trumpet (T-XC) are consistent with the reduced heat accumulation and faster cooling rates achieved through the support-matching control strategy.

FIG. 13B depicts the distribution of Vickers microhardness (HV_{0.3,10}) 1300B for the unsupported, uncontrolled trumpet (T-XU), the unsupported, controlled trumpet (T-XC), and the supported, uncontrolled trumpet (T-SU). Microhardness is a surrogate for mechanical properties including tensile strength and is influenced by the local thermal history and resulting microstructure. As shown in FIG. 13B, the unsupported, controlled trumpet (T-XC) has a mean microhardness (μ) of approximately 224.36 HV with a standard deviation (σ) of approximately 5.36 HV. The supported, uncontrolled trumpet (T-SU) has a mean microhardness of approximately 231.32 HV with a standard deviation of approximately 7.73 HV. The unsupported, uncontrolled trumpet (T-XU) has a mean microhardness of approximately 228.44 HV with a standard deviation of approximately 9.56 HV. Thus, the unsupported, controlled trumpet (T-XC) achieves the smallest variation in microhardness of the three parts, indicating that the support-matching control strategy produces more consistent functional properties than both the unsupported, uncontrolled scenario and the supported, uncontrolled scenario, while also eliminating the need for support structures and the associated post-processing time and cost.

The features, structures, or characteristics described above can be combined in one or more implementations in any suitable manner, and the features discussed in the various implementations are interchangeable. A person skilled in the art will appreciate that the systems and methods disclosed herein can be practiced without one or more of the specific details, or other methods, components, or materials can be employed. In other instances, well-known structures, materials, or operations are not shown or described in detail to avoid obscuring aspects of the present disclosure.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable.

The above-described implementations of the present disclosure are merely possible examples set forth for a clear understanding of the principles of the disclosure. Many variations and modifications may be made to the above-described implementations without departing substantially from the spirit and principles of the disclosure. All such modifications and variations are intended to be included herein within the scope of this disclosure and protected by the following claims.

What is claimed is:

1. A system, comprising:
at least one computing device;
instructions stored in the at least one computing device that, when executed by at least one processor of the at least one computing device, cause the at least one computing device to at least:
receive a digital representation of a part geometry for a part to be fabricated by a laser powder bed fusion (LPBF) process;
predict a thermal history of the part under nominal processing conditions using a thermal model, wherein the thermal model discretizes the part geometry into a plurality of nodes connected by edges to form a network graph, constructs a discrete Laplacian matrix from the network graph, and computes eigenvalues and eigenvectors of the Laplacian matrix;
determine a target thermal history for the part based on a control strategy;
for each of a plurality of layers of the part, iteratively simulate the thermal history of the part at a plurality of candidate processing parameter levels over a prediction horizon of future layers using the thermal model, and select a candidate processing parameter level that minimizes a deviation between the simulated thermal history and the target thermal history over the prediction horizon; and
output a layer-by-layer process parameter plan specifying a processing parameter for each of the plurality of layers of the part based on the selected candidate processing parameter levels.

2. The system of claim 1, wherein the thermal model expresses the thermal history as a product of a part-shape-dependent term derived from the eigenvectors and eigenvalues of the Laplacian matrix and a processing-condition-dependent term, the part-shape-dependent term and the processing-condition-dependent term being decoupled such that the eigenvalues and eigenvectors are pre-computed for each layer and the thermal history is iterative as a function of the candidate processing parameter levels without re-computing the eigenvalues and eigenvectors.

3. The system of claim 1, wherein the control strategy comprises one of:
maintaining a constant end-of-cycle temperature across the plurality of layers;
minimizing a spatial temperature gradient between layers;
maintaining a constant cooling rate across the plurality of layers;
maintaining a constant interlayer time across the plurality of layers; or
matching the thermal history of a reference part fabricated with support structures.

4. The system of claim 3, wherein the control strategy comprises matching the thermal history of the reference part fabricated with the support structures, and the target thermal history is a predicted thermal history of the reference part, such that the layer-by-layer process parameter plan adjusts the processing parameter to replicate the thermal history of the reference part without requiring physical support structures.

5. The system of claim 1, wherein the prediction horizon comprises future layers and the plurality of candidate processing parameter levels comprises discrete laser power levels, and wherein the iterative simulation and selection are repeated at intervals of a control horizon of simulated layers until all layers of the part have been processed.

6. The system of claim 5, wherein each simulated layer corresponds to a plurality of actual layers of the part in a superlayer approach, and the control horizon corresponds to a physical build height interval.

7. The system of claim 1, wherein the instructions further cause the at least one computing device to apply a smoothing operation to the layer-by-layer process parameter plan to reduce changes in the processing parameter between adjacent layers, the smoothing operation comprising a moving average filter applied to the processing parameter across a window of build height.

8. The system of claim 1, further comprising instructions stored in the at least one computing device that, when executed by the at least one processor, cause the at least one computing device to at least:
receive sensor data from an in-situ sensor array during fabrication of the part, the sensor data comprising at least one of thermal imaging data or meltpool intensity data;
extract sensor-derived features from the sensor data;
obtain simulation-derived thermal history quantifiers from the thermal model; and
input the sensor-derived features and the simulation-derived thermal history quantifiers to a machine learning model trained on ground-truth metallurgical characterization data to predict one or more characteristics of a solidified microstructure of the part.

9. A computer-implemented method, comprising:
receiving, by at least one computing device, a digital representation of a part geometry for a part to be fabricated by a laser powder bed fusion (LPBF) process;
predicting, by the at least one computing device, a thermal history of the part under nominal processing conditions using a thermal model, wherein the thermal model discretizes the part geometry into a plurality of nodes connected by edges to form a network graph, constructs a discrete Laplacian matrix from the network graph, and computes eigenvalues and eigenvectors of the Laplacian matrix;
determining, by the at least one computing device, a target thermal history for the part based on a control strategy;
for each of a plurality of layers of the part, iteratively simulating, by the at least one computing device, the thermal history of the part at a plurality of candidate processing parameter levels over a prediction horizon of future layers using the thermal model, and selecting a candidate processing parameter level that minimizes a deviation between the simulated thermal history and the target thermal history over the prediction horizon; and
outputting, by the at least one computing device, a layer-by-layer process parameter plan specifying a processing parameter for each of the plurality of layers of the part based on the selected candidate processing parameter levels.

10. The computer-implemented method of claim 9, further comprising calibrating the thermal model by adjusting heat transfer boundary coefficients based on a comparison of a predicted end-of-cycle temperature to a measured end-of-cycle temperature acquired from a long-wave infrared thermal camera, wherein the heat transfer boundary coefficients comprise a heat loss coefficient from the part to a build plate, a heat loss coefficient from the part to surrounding powder, and a heat loss coefficient from the part to a gas flow.

11. The computer-implemented method of claim 9, wherein the control strategy comprises one of:
maintaining a constant end-of-cycle temperature across the plurality of layers;
minimizing a spatial temperature gradient between layers;
maintaining a constant cooling rate across the plurality of layers;
maintaining a constant interlayer time across the plurality of layers; or
matching the thermal history of a reference part fabricated with support structures.

12. The computer-implemented method of claim 9, wherein iteratively simulating and selecting are repeated at intervals of a control horizon until all layers of the part have been processed, and the method further comprises applying a smoothing operation to the layer-by-layer process parameter plan.

13. The computer-implemented method of claim 9, further comprising:
acquiring in-situ sensor data during fabrication of the part;
extracting sensor-derived features from the in-situ sensor data;
obtaining simulation-derived thermal history quantifiers from the thermal model; and
inputting the sensor-derived features and the simulation-derived thermal history quantifiers to a machine learning model trained on ground-truth metallurgical characterization data to predict one or more characteristics of a solidified microstructure of the part.

14. The computer-implemented method of claim 13, wherein the in-situ sensor data comprises thermal imaging data acquired from a long-wave infrared thermal camera and meltpool intensity data acquired from an optical tomography sensor, and wherein the sensor-derived features comprise an end-of-cycle temperature, a spatial standard deviation of the end-of-cycle temperature, a mean of the meltpool intensity data, and a spatial standard deviation of the meltpool intensity data.

15. The computer-implemented method of claim 13, wherein the machine learning model comprises a nearest neighbors model, and the one or more characteristics of the solidified microstructure comprise at least one of a meltpool depth, a primary dendritic arm spacing, a grain aspect ratio, a grain major axis length, a standard deviation of grain orientation, a crystallographic texture ratio, or a microhardness.

16. A non-transitory computer-readable medium storing instructions that, when executed by at least one processor, cause the at least one processor to at least:
receive a digital representation of a part geometry for a part to be fabricated by a laser powder bed fusion (LPBF) process;
predict a thermal history of the part under nominal processing conditions using a thermal model, wherein the thermal model discretizes the part geometry into a plurality of nodes connected by edges to form a network graph, constructs a discrete Laplacian matrix from the network graph, and computes eigenvalues and eigenvectors of the Laplacian matrix;
determine a target thermal history for the part based on a control strategy;
for each of a plurality of layers of the part, iteratively simulate the thermal history of the part at a plurality of candidate processing parameter levels over a prediction horizon of future layers using the thermal model, and select a candidate processing parameter level that minimizes a deviation between the simulated thermal history and the target thermal history over the prediction horizon; and
output a layer-by-layer process parameter plan specifying a processing parameter for each of the plurality of layers of the part based on the selected candidate processing parameter levels.

17. The non-transitory computer-readable medium of claim 16, wherein the thermal model expresses the thermal history as a product of a part-shape-dependent term derived from the eigenvectors and eigenvalues of the Laplacian matrix and a processing-condition-dependent term, the part-shape-dependent term and the processing-condition-dependent term being decoupled such that the thermal history is iterative as a function of the candidate processing parameter levels without re-computing the eigenvalues and eigenvectors.

18. The non-transitory computer-readable medium of claim 16, wherein the plurality of candidate processing parameter levels comprise a plurality of discrete laser power levels constrained between a lower bound selected to avoid lack-of-fusion porosity and an upper bound selected to avoid keyhole porosity.

19. The non-transitory computer-readable medium of claim 16, wherein the instructions further cause the at least one processor to at least:
receive sensor data from an in-situ sensor array during fabrication of the part;
extract sensor-derived features from the sensor data;
obtain simulation-derived thermal history quantifiers from the thermal model; and
input the sensor-derived features and the simulation-derived thermal history quantifiers to a machine learning model to predict one or more characteristics of a solidified microstructure of the part.

20. The non-transitory computer-readable medium of claim 16, wherein the instructions further cause the at least one processor to transmit the layer-by-layer process parameter plan to slicer software of an LPBF machine for generating machine-executable instructions for fabrication of the part.
